(19) United States
(12) Patent Application Publication
(10) Pub. No.: US 2002/0073005 A1
(43) Pub. Date: Jun. 13, 2002

(54) Computerized lifestyle planning system and method

(76) Inventors: Raymond P. Welnicki, Manchester, CT (US); Hugh Martin, Farmington, CT (US); Michael Boyle, Avon, CT (US); James Scanlon, Simsbury, CT (US); Melissa Baribault, East Hampton, CT (US); Jeff Reiser, Brooklyn, NY (US); Nell Gharibian, Boston, MA (US); Romney Resney, Boston, MA (US)

Correspondence Address: MINTZ, LEVIN, COHN, FERRIS, GLOVSKY and POPEO, P.C., One Financial Center, Boston, MA, 02111, US

(21) Appl. No.: 09/865,279

(22) Filed: May 25, 2001

Related U.S. Application Data
(60) Provisional application No. 60/207,071, filed on May 25, 2000.

(51) Int. Cl. G06F 17/60

(52) U.S. Cl. 705/35; 705/36

(57) ABSTRACT

In one embodiment, the invention provides a computerized method for creating a customized lifestyle plan for a user. The user's desired lifestyle is identified. At least one user preference associated with the desired lifestyle is identified. Financial information associated with the user is identified. The cost of the user's desired lifestyle, in accordance with the user preference, is determined. The desired lifestyle scenario is evaluated to determine whether the desired lifestyle is achievable with respect to the user financial information. If the lifestyle is achievable, a lifestyle plan associated with the desired lifestyle and the financial information is provided to the user.

### PRIORITY

This patent application claims priority to provisional patent application Ser. No. 60/207,071, filed on May 25, 2000, entitled “Computerized Lifestyle Planning System and Method,” which is hereby incorporated by reference.

### FIELD OF THE INVENTION

The present invention relates generally to data processing methods and systems, and more particularly to a computerized lifestyle planning method and system operable over a computer network.

### BACKGROUND OF THE INVENTION

There are many financial advisors, financial portals and financial services companies offering varying lifestyle and retirement tools and calculators via the global interconnection of computers and computer networks commonly referred to as the Internet. By inputting current and estimated future investments, a user of a website as is commonly understood, can estimate projected earnings based on economic assumptions using well-known methods.

Such tools are supplemented to various degrees with specific investment advice, sometimes for a fee, articles about retirement, links to investment accounts, and live advice for example. Traditional sellers of financial products also offer literature on their web sites, often linked to information about their own products. Many of these sites feature links to a company's network of financial advisors and online access to investment accounts. Commonly, these types of sites focus on estimates of retiree income but might not provide guidance for thinking about lifestyle and retirement wishes, needs and goals. Goals visualization and life option prioritization can be totally absent from typical online retirement calculators, which make assumptions about their user's lifestyle and retirement needs without determining the user's preferences about retirement.

### SUMMARY OF THE INVENTION

In one aspect, the invention relates to systems and methods, such as those associated with a web-based interactive application, which feature a unique interactive process designed to allow users to visualize and build a lifestyle scenario that can be unique and exclusively their own. In at least one embodiment, this interactive process offers users an experience that is more user friendly than from that of other websites that provide financial or lifestyle planning advice, such as those offered by traditional financial services firms and/or retirement planning websites. In at least one embodiment, the invention uses resources and estimates of future costs directly correlated with lifestyle preferences indicated by a user, such as housing style, geographic location, hobbies, travel and vacation preferences.

In one embodiment, the invention provides a computerized method for creating a customized lifestyle plan for a user. The user's desired lifestyle is identified. At least one user preference associated with the desired lifestyle is identified. Financial information associated with the user is identified. The cost of the user's desired lifestyle, in accordance with the user preference, is determined. The desired lifestyle is evaluated to determine whether the desired lifestyle is achievable with respect to the user financial information. If the lifestyle is achievable, a lifestyle plan associated with the desired lifestyle and the financial information is provided to the user.

In one embodiment, the invention provides a computerized lifestyle planning system, comprising a database, a rules engine, and a processor. The database stores information about at least one type of lifestyle. The rules engine defines at least one rule relating to the type of lifestyle. The processor is in operable communication with the rules engine and the database. The processor is programmed for receiving user information about a user's desired lifestyle, retrieving data from the database responsive to the user information, in accordance with the at least one rule, and creating a plan for the user to achieve the desired lifestyle, in accordance with the retrieved data.

In at least one embodiment, the invention takes the form of a unique lifestyle or retirement application and web site that helps individuals or families, such as individuals from one or more demographically identified groups (e.g., Baby Boomers) visualize and plan their dream lifestyle and retirement, and then helps them achieve their goals. Through interaction with the application, such as by answering queries posed by the application, users can helps visualize their lifestyle and retirement lives, and the elements in it such as housing, travel, and interests. In another embodiment, the application determines the assets and income needs necessary to finance the dream lifestyle or retirement. The application provides additional services, products and content through commercial partnerships and vendor referrals.

In one embodiment of the invention, the lifestyle planning system achieves at least a portion of its functionality through the use of functions provided by another client, such as a third party financial partner. In an example of this embodiment, a user provides information about the user's dream to the system and receives visual and textual representations of the dream from the system along with an estimate of what that “dream” lifestyle would cost in today's dollars. This information is provided to a financial calculator engine of another entity, such as a financial partner and/or a white label client. When this occurs, to the user it still appears to be the same “session”; that is, the upload and presentation of the financial partner's calculator engine appears to be seamless. The actor inputs financial info into this engine, which can then use that information, along with the current cost of the dream, to project out to retirement both the estimated future assets and income of the user as well as the estimated future costs of the user's dream lifestyle. This projected information is downloaded to the system of the invention, which presents the comparison of future income and future costs to the user and provides recommendations, advice, referrals, etc. relative to that comparison.

Embodiments of the invention may provide advantages such as helping users, especially, Baby Boomers, visualize a desired life in lifestyle and retirement, including such considerations as housing style and hobbies, and travel and vacation preferences, estimating a future cost for each user preference, such as desired housing style, hobbies, travel and vacation preferences, and calculating a total lifestyle or retirement cost therefrom.

Additional advantages of embodiments of the invention may include the ability to match a user's personal financial data against a desired retirement scenario, such as a desired lifestyle in retirement. In at least one embodiment, the present invention uses a financial calculator based on some primary economic assumptions and hard data from current income and investments to determine if a user's retirement scenario is possible, given various financial market environments using conventional economic methodologies. The system according to this embodiment of the present invention then guides the user through creating a financial plan to reach that dream, using economic assumptions and data from current income and investments.

Still other embodiments of the invention may provide advantages such as helping a user create a lifestyle plan based on an existing retirement plan. For example, a user may arrive at a website with a financial plan such as may pertain to a retirement plan and retirement income in place. The user is instructed to go to a summary total page and enter information such as his or her monthly or yearly retirement income. The system advantageously then works backwards from this total and helps the user create a desired retirement lifestyle, or dream retirement. The system may generate a list of retirement scenarios/options to choose from based on the retirement income that the user has entered.

Embodiments of the invention also may provide advantages such as bringing a user's financial position and dream retirement into alignment. For example, if a user's view of his dream retirement and estimated financial position do not match, at least one embodiment of the invention advantageously uses decision logic to provide a series of linked options to bring the two into alignment. If the user is not exactly sure about what his dream retirement scenario looks like, this embodiment provides options to help, easy to understand examples and links to relevant content, e.g. textual articles.

Hence, embodiments of the invent'on may provide benefits such as being able to assist users at many different points in the retirement planning process. For example, a user may easily use one system according to the invention at any point in the retirement planning process, e.g., either before or during retirement, and participate in options prioritization regardless of where he is in the financial planning process, e.g., before, during, or after a financial plan has been created. At least one embodiment of the invention provides a retirement plan in prose format with reader friendly graphical representations as its output. In at least one embodiment, a user can save his previously entered data and then return to where he left off at a future time.

Still more benefits of embodiments of the invention include taking a novel and unique approach to lifestyle and retirement planning such that users begin the process of planning by envisioning where they would like to live and what they would like to be doing when they are retired. More than just a financial questionnaire, a website implemented in accordance with this embodiment prompts the user to elaborate on the specifics of his or her dream lifestyle, such as size and location of home, volunteer work, planning trips around the world, and the like.

In at least one embodiment, the invention uses a system of interrelated inputs and outcomes and a set of decision rules associated with the input preference rankings.

One embodiment of the invention is drawn to a computerized method for providing a suitable lifestyle plan for a user to the user, the method including: determining what type of lifestyle the user would like to live by presenting the user with a plurality of suitable inquiries and receiving data indicative of responses entered on a suitable microprocessor based device by the user; comparing the received data to data contained within a database to calculate an estimated cost of associated with the determined lifestyle; determining financial resources available to the user by presenting the user with another plurality of suitable inquiries and receiving other data indicative of responses entered on the suitable microprocessor based device by the user; generating a retirement plan dependently upon the total cost and other data; and, communicating the generated lifestyle plan to the user utilizing the suitable microprocessor based device.

Thus, some embodiments of the present invention may overcome the significant shortcomings of prior art systems and methods and provide a computerized lifestyle and retirement planning system and method which takes a user's wishes, needs and goals into consideration in identifying a recommended investment or savings plan.

### BRIEF DESCRIPTION OF THE FIGURES

The advantages and aspects of the present invention will be more fully understood in conjunction with the following detailed description and accompanying drawings, wherein:

FIG. 1 is an illustration of a computer system in which at least one embodiment of the present invention can be embodied.

FIG. 2 illustrates as overview of a system according to one embodiment of the invention;

FIG. 3 illustrates an overview of a method of operating the system of FIG. 2 according to one embodiment of the invention;

FIG. 4 is a block diagram of a system according to one embodiment of the invention;

FIG. 5 is a flow chart illustrating a method for lifestyle planning implemented in accordance with one embodiment of the invention;

FIG. 6 is a flow chart illustrating a method for lifestyle planning, from the perspective of a client, in accordance with one embodiment of the invention;

FIG. 7 is a flow chart illustrating a method for lifestyle planning, from the perspective of a server, in accordance with one embodiment of the invention;

FIG. 8 is a flow chart illustrating a method for lifestyle planning using an external application, in accordance with one embodiment of the invention;

FIG. 9 is a screen shot depicting in example welcome screen constructed in accordance with an embodiment of the invention;

FIG. 10 is a screen shot depicting an example navigation screen constructed in accordance with an embodiment of the invention;

FIG. 11 is a screen shot depicting an example navigation screen for the “Place” pathway of FIG. 10;

FIG. 12 is a screen shot depicting another example navigation screen for the “Place” pathway of FIG. 10;

FIG. 13 is a screen shot depicting a summary screen for the “Place” pathway of FIG. 10;

FIG. 14 is a screen shot depicting em example navigation screen for the “People” pathway of FIG. 10;

FIG. 15 is a screen shot depicting another example navigation screen for the “People” pathway of FIG. 10;

FIG. 16 is a screen shot depicting, till another example navigation screen for the “People” pathway of FIG. 10;

FIG. 17 is a screen shot depicting a summary screen for the “People” pathway of FIG. 10;

FIG. 18 is a screen shot depicting an example navigation screen for the “Things to do” pathway of FIG. 10;

FIG. 19 is a screen shot depicting another example navigation screen for the “Things to do” pathway of FIG. 10;

FIG. 20 is a screen shot depicting a summary screen for the “Things to do” pathway of FIG. 10;

FIG. 21 is a screen shot depicting an example navigation screen for the “Things to have” pathway of FIG. 10;

FIG. 22 is a screen shot depicting an example cost query screen for a “Dream” created in accordance with an embodiment of the invention;

FIG. 23 is a screen shot depicting a summary screen for the costs of a “Dream” created in accordance with an embodiment of the invention;

FIG. 24 is a screen shot depicting a calculation tool screen constructed in accordance with an embodiment of the invention;

FIG. 25 is a screen shot depicting a summary screen for projected financial status, created in accordance with an embodiment of the invention;

FIG. 26 is a screen shot depicting an “Explore” screen created in accordance with an embodiment of the invention;

FIG. 27 is a screen shot depicting an album of dream and financial information created in accordance with an embodiment of the invention; and

FIG. 28 is a screen shot depicting one of the pages in the album of FIG. 28.

FIG. 29 is a system architecture for a system according to one embodiment of the invention;

The drawings are not necessarily to scale, emphasis instead generally being placed upon illustrating the principles of the invention.

### DETAILED DESCRIPTION OF THE INVENTION

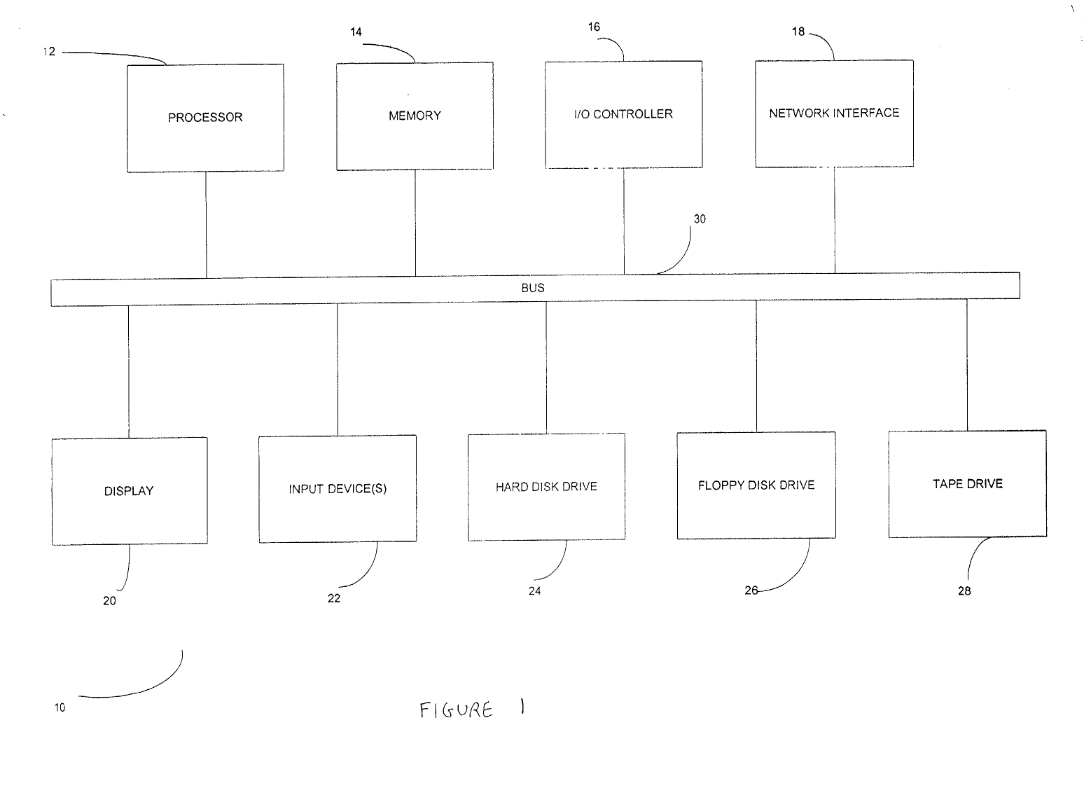

Systems and methods implemented in accordance with the invention can be implemented using any type of general purpose computer system, such as a personal computer (PC), laptop computer, server, workstation, personal digital assistant (PDA), mobile communications device, and the like, running any one of a variety of operating systems. An example of a general- purpose computer system 10usable with one embodiment of the present invention is illustrated in FIG. 1.

Referring briefly to FIG. 1, the general purpose computer system 10 includes a central processor 12, a main memory unit 14 for storing programs and/or data, an input/output controller 16, a network interface 18, a display device 20, one or more input devices 22, a fixed or hard disk drive unit 24, a floppy disk drive unit 26, a tape drive unit 28, and a data bus 30 coupling these components to allow communication therebetween.

The central processor 12 can be any type of microprocessor, such as a PENTIUM processor, made by Intel of Santa Clara, Calif. The display device 20 can be any type of display, such as a liquid crystal display (LCD), cathode ray tube display (CRT), light emitting diode (LED), and the like, capable of displaying, in whole or in part, the outputs generated in accordance with the systems and methods, of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that provides the computer system 10 with network access to a computer or other device, such as a printer. In one embodiment of the present invention, the network interface 18 enables the computer system 10 to connect to a computer network such as the Internet.

Those skilled in the art will appreciate that computer systems embodying the present invention need not include every element shown in FIG. 1, and that equivalents to each of the elements are intended to be included within the spirit and scope of the invention. For example, the computer system 10 need not include the tape drive 28, and may include other types of drives, such as compact disk read-only memory (CD-ROM) drives. CD-ROM drives can, for example, be used to store some or all of the databases described herein.

In at least one embodiment of the invention, one or more computer programs define the operational capabilities of the computer system 10. These programs can be loaded into the computer system 10 in many ways, such as, via the hard disk drive 24, the floppy disk drive 26, the tape drive 28, or the network interface 18. Alternatively, the programs can reside in a permanent memory portion (e.g., a read-only-memory (ROM)) chip) of the main memory 14. In another embodiment, the computer system 9 can include specially designed, dedicated, hard-wired electronic circuits that perform all functions described herein without the need for instructions from computer programs.

In at least one embodiment of the present invention, the computer system 10 is part of a client-server system, in which a client sends requests to a server and a server responds to requests from a client. That is, the computer system 10 can be either a client system or a server system. In one embodiment, the invention is implemented at the server side and receives and responds to requests from a client.

The client can be any entity, such as a the computer system 10, or specific components thereof (e.g., terminal, personal computer, mainframe computer, workstation, hand-held device, electronic book, personal digital assistant, peripheral, etc.), or a software program running on a computer directly or indirectly connected or connectable in any known or later-developed manner to any type of computer network, such as the Internet. For example, a representative client is a personal computer that is x86-, PowerPC.RTM., PENTIUM-based, or RISC-based, that includes an operating system such as IBM.RTM, LINUX, OS/2.RTM. or MICROSOFT WINDOWS (made by Microsoft Corporation of Redmond, Wash.) and that includes a Web browser, such as MICROSOFT INTERNET EXPLORER, NETSCAPE NAVIGATOR (made by Netscape Corporation, Mountain View, Calif.), having a Java Virtual Machine (JVM) and support for application plug-ins or helper applications. A client may also be a notebook computer, a handheld computing device (e.g., a PDA), an Internet appliance, a telephone, or any other such device connectable to the computer network.

The server can be any entity, such as the computer system 10, a computer platform, an adjunct to a computer or platform, or any component thereof, such as a program that can respond to requests from a client. Of course, a “client” can be broadly construed to mean one who requests or gets the file, and “server” can be broadly construed to be the entity that downloads the file. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions and the like.

In addition, software embodying the present invention, in one embodiment, resides in an application running on the computer system 10. In at least one embodiment, the present invention is embodied in a computer-readable program medium usable with the general purposes computer system 10. In at least one embodiment, the present invention is embodied in a data structure stored on a computer or a computer-readable program medium. In addition, in one embodiment, the present invention is embodied in a transmission medium, such as one or more carrier wave signals transmitted between the computer system 10 and another entity, such as another computer system, a server, a wireless network, etc. The present invention also, in an embodiment, is embodied in an application programming interface (API) or a user interface. In addition, the present invention, in one embodiment, is embodied in a data structure.

For the purpose of explanation, embodiments of the present invention will be discussed in connection with the example of lifestyle and retirement planning. It should be understood, however, that the foregoing explanation of the embodiments of the present invention is equally applicable to other types of lifestyle planning as well, such as college tuition planning or career planning.

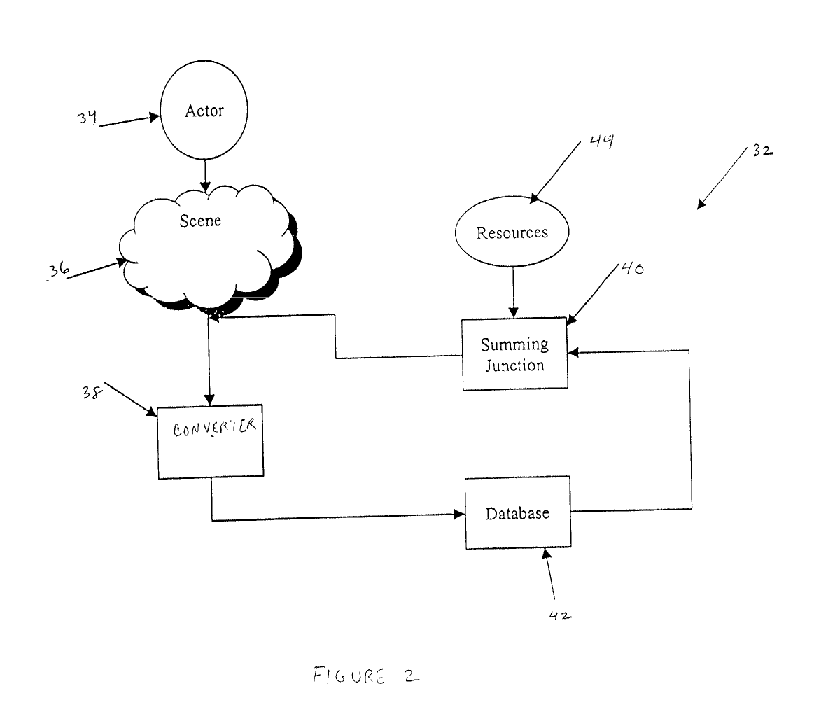

Referring now to FIG. 2, there is illustrated an overview of a system 32 according to one embodiment of the present invention. The system 32 comprises a converter 38, a summing junction 40, and one or more databases 42, in communication with resources 44 and a scene 36, which interacts with an actor 34 (which also will be referred to throughout this description as a user). The “Actor” 34 is a user of the system 32, such as a client, a person, a group of persons, or another application. Thus, in one embodiment of the invention, a user or actor can be defined as anything that touches or communicates with an application implemented in accordance with an embodiment of the invention. In one embodiment, actors 34 are humans or other systems 30 such as those run by an organization authorized to do so by the operator of a system according to the present invention.

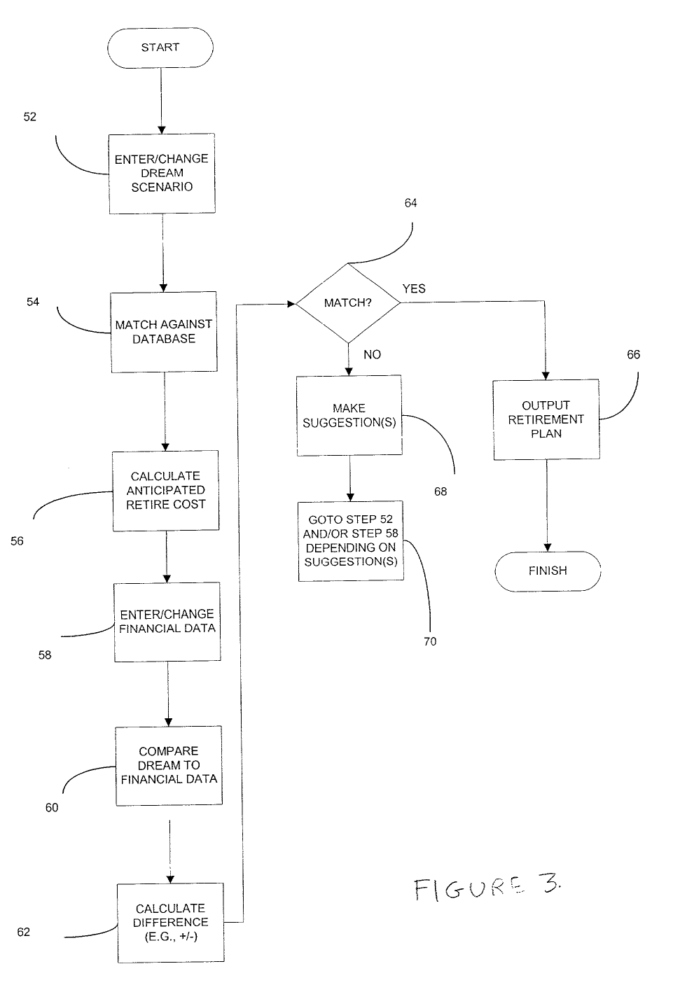

Through a question and answer format presented through a browser application such as NETSCAPE NAVIGATOR or INTERNET EXPLORER being run on a suitable device (such as the system 10 of FIG. 1), the actor 34 submits preferences, through a “Scene” 36, relating to his future retirement to the system 32. The scene 36 is the web-based screen/user interface that the actor 34 sees when inputting information. In one embodiment, at least a portion of the system 32 is visible to the actor 34 through the Internet or other suitable communications medium. The Web site/page, in one embodiment, changes as the user inputs information and moves to different input points in the application. The scene 36 reflects a visualization of the information inputted into the converter 38 and the results coming from the summing junction 40. In one embodiment of the invention, the scene 36 ( is revised with each summing junction 40 calculation (e.g., steps 56, 63, 64 of FIG. 3).

The preferences of the actor 34 are fed into a converter 38 that acts as a conduit for the actor 34 to consider his retirement options and possibilities. In one embodiment of the invention, the converter 38 is a system that enables the actor 34 to analyze, investigate and synthesize a retirement scenario by providing information to the actor 34 and receiving information from the actor 34. As those skilled in the art will appreciate, the converter 38 may be implemented in hardware, software, or a combination of the two. The information received from the actor 34 is then fed to the database 42.

The information contained within database 42 is based on information deemed relevant to the lifestyle planning, such as travel rates, housing costs based on sizing, location, the cost associated with various tax information, and other information that has been inputted and stored in the database 42 based upon the economic methodology (ies) applicable in the given embodiment of the invention.

The summing junction 40 is a system capable of performing predetermined operations, such as computations, on information that is provided to it. Like the converter 38, the summing junction may be implemented in hardware, software, or a combination of the two. The functions and features of the converter 38 and the summing junction 40 are explained more fully herein.

Resources 44, in one embodiment of the invention, take the form of servers, application software, and tools that drive the calculations of the summing junction 40.

Referring now also to FIG. 3, therein is illustrated a process 50 of retirement planning utilizing the system 32 of FIG. 2, in accordance with one embodiment of the invention. As will be described herein, the process 50 can be used for various “phases” of lifestyle planning, including the “dream” phase and the “planning” phase. In the “dream” phase of the interaction of the actor 34 with converter 38, the actor 34 enters “dream scenarios” (step 52) of what he envisions his dream retirement to “look like”.

Entries at step 52, in accordance with one embodiment of the invention, include entries such as preferences in housing location, style, size, hobbies and interests, and travel. These entries help the actor 34 to build a scenario of his desired retirement lifestyle. In one embodiment of the invention, the first interaction between the actor 34 and the converter 38 does not require the actor 34 to enter detailed financial information, but rather prompts the actor 34 to input what he wants his life to look like on multiple dimensions. In one embodiment, as the actor 34 enters information, the information is processed so that the actor can receive subsequent textual and visual results that are based at least in part on the processed information. In one embodiment, these results are provided almost immediately after providing information. Thus, in one embodiment, the actor 34 enters information in “stages,” and, as parts of the information are assimilated, is provided evolving textual and visual results

For example, one prompt to an actor 34 for visualizing a lifestyle is visualizing an ideal home. The actor 34 is asked to flesh out details regarding a dream retirement home, including such aspects as location and size, and more subtle aspects like access to public transportation, proximity to shopping, trails, golf, water access, sidewalks, wheelchair access, pools, and security.

In one embodiment, the actor 34 enters these “dimensions” by responding to inquiries. These inquiries are presented to the actor 34 via a web browser using well-understood methodology. Inquires used can, for example, include queries such as:

Will you stay in your current home?

If so, do you plan to own a second home?

Where would you like to live? (region, state, country, city)

What type of area would you like to live in (Beach town, mountain resort)

What style of home do you prefer? (condo, town house, stand alone house, CCRC)

How big will your home reed to be? (# of rooms, square footage, garage, acreage)

Would you like to rent or own your home?

Responsive to the converter 38, the system 32 asks the actor 34 about other relevant activities, such as indicating his level of interest and involvement in hobbies, sports, travel, and the like. For example, actors 34 may be prompted to enter information about various hobbies or activities: hiking, swimming, golfing, horseback riding, boating, gaming, skiing, theatre/art/museum, or volunteer service for example. Inquiries used can include for example:

Which hobbies/activities are you interested in?

How frequently will you participate/play?

Will you buy or rent equipment?

Do you plan to start a new career?

Do you want to go back to school? (how many courses per year)

The system 32 can, for example, query an actor 34 about the type of travel they plan to do during retirement. The travel can be domestic or international and can be any type of travel from recreational (RV) to trains to cruises, for example. Actors 34 also may be presented with an opportunity to indicate their interest in discount or last-minute travel opportunities. Inquiries used to evoke this information include for example:

How many trips would you like to take?

Where would you like to travel?

What type of lodging do you prefer? (first class, mid-range, economy)

How many will be traveling?

What mode of travel do you prefer? (airplane, cruise, tour, safari, camping, RV)

Will you buy or rent transportation? (RV? Motorcycle?)

Would you be able to take advantage of last-minute tour/travel deals?

Would you be able to plan in advance to take advantage of lower fares?

For how long would you like to travel?

In one embodiment, the actor 34 provides the anticipated number of years until his retirement and whether he is planning for one or two. Those skilled in the art will understand the format and type of these and other relevant queries, any one or more of which may be included as part of the entering of the dream scenario (step 52). The converter 38, in one embodiment, uses a graphical user interface (GUI), which provides a visual depiction of the evolving information inputted into the converter 38 by the user actor 34 at step 52.

Referring to FIGS. 2 and 3, the information provided by the actor 34 to the converter 38 is matched against database information contained within database 42 (step 54) to calculate an anticipated cost of retirement (step 56) using summing junction 40. The actor 34 enters personal financial information (step 58) into converter 38, and this information is compared with database information (step 60) and a difference is calculated (step 62).

The financial information entered in step 58, in one embodiment, includes information such as name, address, income, investments, home value/location, and other retirement assets. In one embodiment, at least a portion of this or other data is uploaded from an external program, such as home finance programs like MICROSOFT MONEY or QUICKEN (available from Intuit of Mountain View, Calif.). In one embodiment, an actor 34 is prompted to enter other relevant information that might impact a lifestyle or retirement planning, such as age of retirement, dependents, outstanding debt, Dr disabilities. Examples of inquiries that may be used to evoke such information include:

Enter personal information (current age, age of planned retirement)

Current investment portfolio? (stocks, bonds, mutual funds, checking and savings accounts)

Current income? (salary and bonuses)

Annual investment contribution? (401 K, savings etc.)

How much do you want to leave in your estate for heirs?

Will you work during retirement? Full/part time? For how many years?

What is the current value of your 401 K or pension?

What is the current value of home? How much equity do you have? Will you keep it or sell it?

Will you be receiving additional money before or during retirement? (inheritance)

The information entered in step 523 is provided to the one or more databases 42 for comparative information on anticipated investment growth and inflation rates to be retrieved. The database 42 and the information entered in step 58 are compared (step 60) and a difference is calculated (step 62) using summing junction 40. This provides a series of outputs that indicate how close the actor 34 is to realizing his or her dream retirement lifestyle.

If the scenario and financial data are incompatible, as determined at step 64, the actor 34 is provided with options and/or suggestions (step 68) about how he can reconcile his dream with his financial resources as entered. Depending on the option and/or suggestion, the actor 34 may be prompted to modify his dream scenario and/or his financial data (step 70), such as by presenting one or more of the relevant queries associated with these steps again. For example, in one embodiment, the actor 34 is prompted with choices for revising the information entered at both steps 52 and 58. These options can, for example, include suggestions like changing housing locations, making housing payments earlier, increasing savings and other options based on the individual's specific scenario for example. The options suggested in step 68 may include any action or set of actions that might bring the actor 34's financial resources and desired retirement scenario into accord. In accordance with the economic methodology of one embodiment of the invention, when the actor 34's financial resources and lifestyle or retirement scenario are in accord, the desired retirement scenario is reasonably attainable with the entered financial resources.

In one embodiment of the invention, a retirement plan is generated (step 66) if the desired retirement scenario is reasonably attainable. The retirement plan (which is an example of a lifestyle plan, in accordance with one embodiment of the invention) is designed according to the aforementioned economic methodology to enable the user to live the described retirement lifestyle using the financial resources entered and to identify a suggested course of action.

Referring more particularly to the database 42 of FIG. 2, in one embodiment, information inputted to the converter 38 is matched (step 64) with the information from database 42. This data is aggregated and correlated with preferences that the actor 34 provided to the converter 38 in steps 52 and 54. The data is provided to the summing junction 40 for the calculations of steps 56 and 63. In one embodiment, the database 42 stores information such as:

Cost of living, taxes for various regions

Availability of homes, Taxes

Average cost of home size relative to region

Rental cost in a given region

Cost of membership or fees for listed hobbies

Cost of equipment for hobbies

Cost of continuing education

Vacation costs (Airfare, transport, lodging)

Asset allocation models

Anticipated inflation costs

In one embodiment of the invention, the summing junction 40 is where the impact of the preferences provided to the converter 68 and data from database 42 is aggregated. The summing junction 40 integrates the consideration of resources that the actor 34 has available and generates suggestions (step 68) to the actor 34 on how to alter his preferences in order to maximize his existing resources using conventional methodology. The resulting information/data is fed back to the converter 38 where the actor 34 can alter or edit the entered preferences and begin the cycle again. The system 32, in one embodiment, relies on data within database 42 that is accessible. Making use of predetermined parameters, the system 32 evaluates variables, searches within the database 42 and matches cost/numbers with the preferences entered by the actor 34.

Thus, in one embodiment, the summing junction 40 matches (step 64) the inputs (step 52) of the actor 34 from the converter 38 regarding his desired retirement lifestyle with corresponding data from the database 42 indicating how much each of those preferences will cost. The system 32 calculates (step 56) a total estimated cost for the actor 34 and provides it to the converter 38 to allow the actor 34 to modify or continue. The summing junction 40 compares (step 60) the inputs of the actor 34 with the database 42 to calculate what money will be available at the time of retirement. Using summing junction 40, the personal financial data is calculated (step 62) with the “dream” data provided in step 52, applying, for example, general assumptions about the growth of investments, inflation, and Social Security income stored in the database 42. This is used to generate an indicator as to whether the desired retirement scenario is feasible (step 64).

When the “dreaming” is completed, the system 32 estimates the cost of the dream retirement and the ability of the actor 34 to attain this retirement given his inputs to the converter 38 and the information stored in the database 42 (step 62) using, for example, conventional economic methodologies.

If the scenario and financial data compared at step 64 do not match, the system 32 may generate options (step 68) to help bring the retirement lifestyle into an attainable range. These options may include eliminating club memberships, scaling back travel, decreasing the size of the home, changing housing locations and so on, based on the individual inputs by user during the “dream” phase. In one embodiment, a user is linked to the planning phase, providing options for changing the personal savings/investment information (e.g., increasing annual savings or 401 K investments). Based on the tolerance of the actor 34 for risk, built-in asset allocators can recommend a proper investment mix (stocks, bonds, and money market accounts). When this phase of the planning is completed, and the difference calculated at step 62 is within an acceptable predefined range, a retirement plan is issued (step 66).

According to an embodiment of the present invention, at any point in the process, actors 34 may save their scenarios and leave the site. When they return, they will be able to return to the dream “in progress” or begin a new dream. In one embodiment, actors 34 are alerted quarterly on the progress of their plan via email. These e-mails can, in one embodiment, encourage the recipient actors 34 to continue to visit and “dream” at the site. Multiple dream scenarios can preferably be stored for each identifiable actor 34.

In one embodiment of the invention, the method of FIG. 3 works in conjunction with one or more functions/processes provided by another client, such as a third party financial partner, to perform at least a portion of the illustrated steps. For example, in accordance with the method of FIG. 3, the actor provides information about his dream and receives visual and textual representations of the dream along with an estimate of what that “dream” lifestyle would cost in today's dollars. This information is provided to a financial calculator engine of another entity, such as a financial partner and/or a white label client. When this occurs, to the user it still appears to be the same “session”; that is, the upload and presentation of the financial partner's calculator engine appears to be seamless. The actor inputs financial info into this engine, which can then uses that information, along with the current cost of the dream, to project out to retirement both the estimated future asset, and income of the user as well as the estimated future costs of the user's dream lifestyle. This projected information can be provided, for example, as the retirement plan of step 66. This retirement plan, in one embodiment, presents the comparison of future income and future costs to the user and provides recommendations, advice, referrals, etc. relative to that comparison.

The following sample scenarios are for one embodiment of the invention created in accordance with FIGS. 2 and 3, wherein the scenario 36 takes the form of a website (not shown) accessible via a computer network, such as the Internet.

### EXAMPLE 1

An actor 34 visits the web site using a browser running on a conventional personal computer and enters data relating to at least some of the inquiries present, e.g. housing, hobbies and travel dreaming stages and enters his personal retirement preferences. The system 32 computes a total cost for that retirement lifestyle based on the input information. The actor 34 then leaves the website.

### EXAMPLE 2

An actor 34 visits the website, goes through all, or a portion, of the housing, hobbies and travel dreaming stages and enters his personal retirement preferences. The system 32 computes a total cost for that retirement lifestyle based on the input information. The actor 34 then enters personal financial data. The system 32 matches this personal financial information with the dream retirement preferences and creates a Dream Retirement Plan for the actor 34. The actor 34 then leaves the website.

### EXAMPLE 3

An actor 34 visits the website, goes through all, or a portion of the housing, hobbies and travel dreaming stages and enters his personal retirement preferences. The system 32 computes a total cost for that lifestyle or retirement based on the input information. The actor 34 then enters personal financial data. The system 32 matches this personal financial information with a lifestyle such as the dream retirement preferences and creates a Dream Retirement Plan for the actor 34. The actor 34 is asked whether he/she would like to change the preferences in his dream. The user returns to the dreaming stages for housing, travel and hobbies and revises information, perhaps more than once, based on the suggestions that the system 32 recommends in the Dream Retirement Plan. A revised Dream Retirement Plan is generated based on the newly update preferences and/or financial data. The actor 34 then leaves the website.

### EXAMPLE 4

An actor 34 visits the website, goes through all, or a portion, of the housing, hobbies and travel dreaming stages and enters his personal lifestyle or retirement preferences. The system 32 computes a total cost for that lifestyle or retirement based on the input information. The actor 34 then enters personal financial data. The system 32 matches this personal financial information with, for example, the dream retirement preferences and creates a Dream Retirement Plan for the user. The user is then referred either to the online financial advice partner and pays for online financial advice or is referred to offline financial partner for further financial planning advice.

### EXAMPLE 5

An actor 34 visits the website, goes through all, or a portion, of the housing, hobbies and travel dreaming stages and enters his personal lifestyle or retirement preferences but leaves the site without completing the entries or having the system 32 compute a cost for the lifestyle described. The user returns at a later time/date and is able to resume the dreaming at the point in the process where he/she previously left off.

### EXAMPLE 6

A previous actor 34 who has visited the website and entered personal preferences and financial information has a Dream Retirement Plan stored in the system 32.The system 32 sends email notification to the actor 34 that his Dream Retirement Plan needs to be updated. The actor 34 returns to the website, and either revises the dream retirement preferences, or revises his personal financial information. A revised Dream Retirement Plan is generated based on the newly update preferences and/or financial data. The actor 34 then leaves the site.

### EXAMPLE 7

A previous actor 34 who has visited website and entered personal preferences and financial information has a Dream Retirement Plan stored in the system 32. The actor 34 returns some time later and begins an entirely new dream, while keeping the old one stored. The new dream retirement preferences are stored under a different dream name.

### EXAMPLE 8

An actor 34 visits the website, goes through all, or a portion, of the housing, hobbies and travel dreaming stages and enters his personal lifestyle or retirement preferences. The system 32 computes a total cost for that retirement lifestyle based on the input information. The actor 34 then goes directly to partner sites relating to identified information entered by the actor 34 such as travel, housing, hobbies and content through onsite hot links.

### EXAMPLE 9

An actor 34 goes to website and is confused on how the site works. He goes to a tutorial/“Previous Dream” section that provides a tutorial on how to use the website. He can see other pre-constructed dreams and is given helpful hints that can help make his experience more enjoyable.

### EXAMPLE 10

An actor 34 goes to the website and begins to input data needed to create his dream. The actor 34 realizes that he needs help and wants to ask questions. The website provides answers to (FAQ's) Frequently asked Questions. The actor 34 can return to where hey left off or send e-mail for help on various topics. The website can further offer a referral service to a professional financial advisor who is familiar with using the system 32 and creating a personal dream lifestyle or retirement scenario.

### EXAMPLE 11

The actor 34 arrives at the website with a lifestyle or retirement plan and income for such in place, for example from an online or offline financial planner. The actor 34 is instructed to go to the summary total page and enter his monthly or yearly lifestyle or retirement income information. The system 32 then works backwards from this total and help the actor 34 create a dream retirement that is within his limits. The system 32 preferably generates a list of retirement scenarios/options to chose from based on the lifestyle or retirement income that the actor 34 has entered (without having to go through the personal financial portion of the application.)

Table-1 includes a table of examples of functionality of a lifestyle planning system implemented in accordance with one embodiment of the invention.

TABLE 1

| Case # | Functionality | System Goals Addressed |
|---|---|---|
| 1 | Maintain Account | General |
| 1.1 | Register to Use | General |
| | Present system | |
| 1.2 | Log into Present system | General |
| 1.3 | Change Customer Profile | General |
| 2 | Maintain Dream | General |
| 2.1 | Create New Dream | Wants to understand retirement |
| | | lifestyle options |
| | | Use Present system to explore |
| | | options with clients |
| | | Use Present system as tool to |
| | | encourage customers to purchase |
| | | financial advisement and |
| | | products |
| | | Wants to understand retirement |
| | | lifestyle options |
| 2.2 | Read New Dream | General |
| 2.3 | Update Dream | Wants to see how dream is |
| | | affected by changing elements of |
| | | the dream lifestyle |
| 2.4 | Delete Dream | General |
| 2.5 | Save Copy of Dream | General |
| | Under New Name | |
| 2.6 | Save Dream | Wants to see how dream is |
| | | affected by changing elements of |
| | | the dream lifestyle |
| 3 | Maintain Finances | Wants to see how dream is |
| | | affected by changing elements of |
| | | the dream lifestyle |
| 3.1 | Create Financial Information | Wants flexibility in how she/he |
| | | goes through the application |
| | | Wants to see if he or she is |
| | | planning sufficiently |
| 3.2 | Read Financial Information | |
| 3.3 | Update Financial Information | Seek constant updates and |
| | | summary of saved dream |
| 4 | Reconcile Dream | Explore options based on |
| | | previously estimated future |
| | | income |
| | | Wants to know the bottom line |
| | | Wants estimates for desired |
| | | lifestyle |
| 4.1 | Reconcile Dream and | Potentially adjust plan based on |
| | Financial Information: | lifestyle estimates |
| | Present system | Wants to know what goals are |
| | | realistic |
| | | Compare costs to projected |
| | | income |
| 4.2 | Reconcile Dream and | Explore options based on |
| | Financial Information: | previously estimated future |
| | White Label | income |
| | | Wants to see if he or she is |
| | | planning sufficiently |
| 5 | View Vendor Referrals | Wants to establish peer groups |
| | | Wants to explore new activities |
| | | Wants to establish peer groups |
| | | Wants to explore new activities |
| | | Wants to check out latest referral |
| | | list |
| 5.1 | View Vendor Referrals: | See Use Case 5 |
| | Present system Customer | |
| 5.2 | View Vendor Referrals: | See Use Case 5 |
| | White Label Customer | |
| 6 | Explore Present system | Find out more about Present |
| | | system |
| 6.1 | Explore How to Contact | See Use Case 6 |
| | Present system | |
| 6.2 | Explore About Present system | See Use Case 6 |
| 6.3 | Explore for Sample Dreams | See Use Case 6 |
| 6.4 | Explore for Help | See Use Case 6 |
| 7 | Maintain Present system | Easily add content and make |
| | | changes |
| | | Personalized access to Present |
| | | system for ease of maintenance |
| | | Wants to see if he or she is |
| | | planning sufficiently |
| | | Wants to track changes in the |
| | | dream based on investment |
| | | performance |
| 8 | Provide Information to | Wants easy way to send content |
| | Present system | to Present system employee |
| | | Wants to provide Present system |
| | | with data using a low cost/high |
| | | revenue format |
| | | Wants to build ongoing |
| | | relationship with Present system |
| 9 | Maintain Vendor Referrals | Wants to gain customers through |
| | | Present system |
| | | Wants data sharing between |
| | | Present system and his/her |
| | | own site |
| 10 | Maintain White Label | Wants to please customers while |
| | | increasing product/service sales |
| | | Wants to mold application to |
| | | meet his/her needs (Branding) |
| | | Wants data sharing between |
| | | Present system and his/her |
| | | own site |

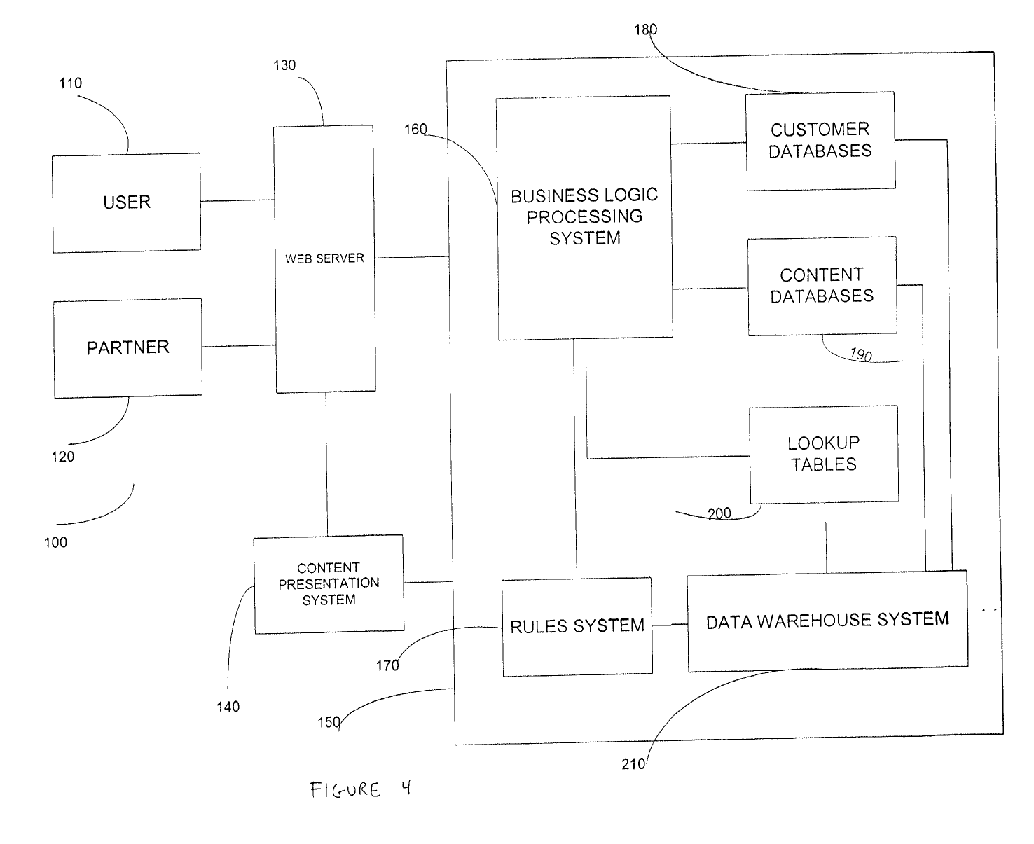

FIG. 4 is a block diagram 100 of a system according to one embodiment of the invention. In the system of FIG. 4, a user 110 interacts with the lifestyle management system 150 via a web server 130 and a content presentation system 140. The lifestyle management system 150 includes a business logic processing system 160, a rules system 170, one or more customer databases 180, one or more content databases 190, one or more lookup tables 200, and a data warehouse system 210. In one embodiment, the lifestyle management system 150 of the invention also is accessible to one or more partners 120.

The user 110 is any type of entity, such as a client (see FIG. 1) capable of interacting with the Internet, a remote server, or a networked device, such as by using of a web server 130. For example, the community of possible users 110 includes users of devices that can interact with web sites that are accessible via web browsers, including users 110 that gain such access using a hypertext transfer protocol (HTTP), wide area protocol (WAP), digitized voice signals, interactive television signals, electronic mail systems, voice mail, direct mail, and various messaging systems, including short message service (SMS) systems.

In one embodiment (not shown), the user 110 interacts directly with the lifestyle management system 150 without requiring use of a web server. For example, the lifestyle management system 150 is, in one embodiment, implemented using a computer-readable program medium installed or loaded to a computer (not shown) accessible to the user 110. In another embodiment, the lifestyle management system 150 is provided on one or more carrier wave signals that are accessible to the user 110 without requiring access to a web server 130.

The web server 130 can be virtually any type of web server known to those skilled in the art, such as a web channel server (e.g., servers produced by Apache or Iplanet), a simple mail transfer protocol/post office (SMTP/POP) server (e.g., servers such as MICROSOFT EXCHANGE or Java Mail API), or an extensible markup language (XML) gateway server.

The content presentation system 140 provides content to the web server 130, for display to the user 110. The content, in one embodiment of the invention, includes queries, printed reports, and/or online reports. In one embodiment of the invention, the content presentation system 140 comprises a content management system and one or more XSL presentation layers. Although not illustrated in FIG. 4, in one embodiment of the invention, the content presentation system 140 is part of the lifestyle management system 150.

The lifestyle management system 150 creates queries to be provided to a user 110, receives responses to the queries, performs processing based at least in part on the queries and the responses, along with information stored in its databases and lookup tables, determines the requirements for a given lifestyle, creates lifestyle plans based at least in part on the requirements, and helps the user 110 explore the potential lifestyle. In one embodiment, the lifestyle management system 150 of the invention is implemented in accordance with “Enterprise class” standards. In one embodiment, the lifestyle management system of the invention is implemented in accordance with transactional-level standards.

In one embodiment, the architecture of the lifestyle management system 150 is a flexible, XML-compliant design that includes real-time, database-resident support of all web site user information. This design permits true closed loop marketing capabilities that can take advantage of highly personalized, E-mail/WAP/Voice-based drive to web marketing. In one embodiment, as content is added to the lifestyle management system 150 (e.g., in content databases 190), the attributes of the content can be compared with a profile of a user 110 (stored, for example, in customer databases 180) using a set of rules (e.g., the rules system 170), and notification of such content (or the content itself) be delivered to the user 110 in near real time, using, for example a report generated in the data warehouse system 110 and presented to the user via the content presentation system 140.

The business logic processing system 160 receives query responses from the web server 130, uses the responses to update the customer databases 180, retrieves data and information from the customer databases 180, content databases 190, and lookup tables 200, and communicates with the rules system 170 to apply one or more predetermined business rules to the user queries, to provide inputs to and receive output from the data warehouse system 210. The predetermined business rules, for example, may relate to economic assumptions, financial calculations, statistical calculations, demographic factors, and the like. The functions of the business logic processing system 160, in one embodiment, are accomplished using Java features such as servlets and Enterprise Java Beans (EJB), which help the lifestyle management system 150 to be platform-independent.

The data warehouse system 210 communicates with the customer databases 180, the content databases 190, the lookup tables 100, and the rules system 170, to prepare reports which may be provided to the user 110, such as with an on-screen display. The data warehouse system 170 also organizes and stores data generated using the business logic 160 and the rules system 170 in databases such as relational online analytical processing databases (ROLAP). The functions of the data warehouse system 210, in one embodiment, are accomplished using servlets, EJB's, and data warehouse reporting tools (such as BRIO, available from Brio Technology, Santa Clara, Calif.).

The rules system 170 processes the data it receives in accordance with one or more predetermined business rules. In one embodiment, the rules system 170 includes a rules engine, such as a Java-based rules engine, to perform the processing (such as the rules engine BLAZE, manufactured by Blaze Software of San Jose, Calif. and/or the rules engine ILOG, manufactured by ILOG, Inc., of Mountain View, Calif.). In one embodiment, the rules system 170 includes a repository for storing the rules it uses, such as a rules repository operating in accordance with a lightweight directory access protocol (LDAP). In one embodiment of the invention, the rules engine communicates with the lifestyle management system in accordance with remote method invocation (RMI) requirements and/or Java message service (JMS) requirements.

The customer databases 180 include one or more databases for storing data provided by users 110 and/or derived from inputs by users 110. For example, in one embodiment, the customer databases 180 process and store data received from users in accordance with an online transaction processing (OLTP) methodology (this methodology can process transactions as soon as the relevant information is received and then update related master files almost immediately in an associated database management system). In one embodiment, the customer databases 180 store and retrieve derived customer data (e.g., dreams, plans, and/or costs created based on inputs by users 110) in databases such as ROLAP databases.

In one embodiment, the customer databases 180 have real-time (OLTP) capabilities, which permits support of a ROLAP Data Warehouse (e.g., the data warehouse system 210) that supports standardized and custom built online marketing analytics reporting. In one embodiment, the data warehouse system 210 supports such reports under a secure Intranet model. In one embodiment, the online marketing analytics analysis reporting is available as a pure web application as well as through a client side application with ad-hoc reporting capabilities.

The content databases 190 include one or more databases storing content that may be provided to a user 110 during operation of the system. In one embodiment, the content databases 190 are implemented in accordance with OLTP methodology. In one embodiment, the content databases 190 include data such as census data, demographic data (e.g., household size, age ranges, education level, household income, consumer lifestyles, ethnicity), and the like.

The lookup tables 200 respond to queries from the business logic processing system 160 (which may originally have been provided by the user 110) and provide information such as responses, reports, charts and/or graphics related to specific inquiries from a user 110 (e.g., an actor). For example, the user 110 may query the lifestyle management system 150 as to the demographic profile of a particular community, the number of museums within a specified distance of a particular zip code, the number of homes of a particular price or market value range within a cluster of zip codes, or other such queries. This type of data may already be in the content databases 190, but may be more quickly and conveniently be provided by the lookup tables 200. The lookup tables 200 contain a subset of the data included in the content databases 190. The design of the lookup tables 200 is intended to facilitate quick response to the queries such as those described above in an easy to understand format.

In one example embodiment, the content databases 190 and/or the lookup tables 200 include databases that have data that is “scored” in advance as to one or more predetermined characteristics. This is also referred to as “derived” data. The scored data can, for example, be maintained as a set of one or more tables of scores. In one embodiment, every zip code in the United States is assigned one or more scores based on certain demographic information. For example, a given zip code may be assigned a first score relating to the average income level within the zip code, a second score relating to the average housing cost within the zip code, a third score relating to the number of museums, and so on. Thus, when a user 110 indicates, as part of his “dream”, that she wants to live in an area having certain characteristics (e.g., low crime rate, low housing cost, lots of recreational facilities, etc.), the table of scores is checked to find locations having the best “scores” for each of the characteristics the user 110 has deemed important.

In one embodiment of the invention, one or more partners 120 also can access the lifestyle management system 150. The partners 120, in one embodiment, are entities having an affinity partnership arrangement with the administrators of the lifestyle management system 150. For example, providers of financial planning services, travel agencies, real estate agents, etc., may arrange to communicate with the lifestyle management system 150 to receive information, such as contact information, demographic information, etc., relating to users 110 and or their “dreams,” including lifestyle planning information. For example, in one embodiment, a partner 120 is an entity, such as a mutual funds company, having direct management responsibility over resources, such as retirement funds, belonging to the user 110. This enables the partner 120 to provide helpful information, including personal financial data, to the lifestyle management system 150 to enable the user 110 to better utilize its planning features.

In the above description of FIG. 4, it should be understood that any portion of the functionality provided by the lifestyle management system 150 could, in some embodiments, be provided by independent systems and/or different groupings of systems than illustrated in FIG. 4. For example, in one embodiment, the lifestyle management system 150 comprises a business logic processing system 160and a rules system 170, but is in operable communication with one or more other systems providing access to one or more of the customer databases 180, content databases 190, lookup tables 200, and data warehouse system 210, and may further be in operable communication with one or more systems providing access to tools such as a financial planning engine (e.g., a “white label client.” engine).

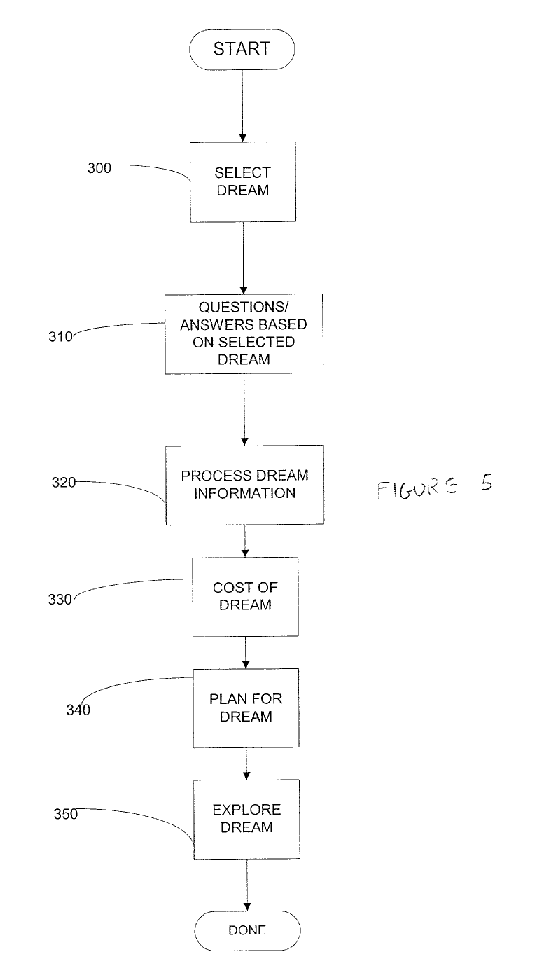

FIG. 5 is a flow chart illustrating a method for lifestyle planning implemented in accordance with one embodiment of the invention. This method may be implemented in many different ways, as those skilled in the art will appreciate, including using a computer readable program medium, a computer program product, a computer signal embodied in a transmission medium (such as a carrier wave), an interlace, a computer-readable medium containing one or more data structures, etc. For example, in one embodiment of the invention, the method of FIG. is implemented in an application executing on a computer system such as the one described in connection with FIG. 1. This method, in one embodiment, is implemented using the lifestyle planning system 150 of FIG. 4.

Referring to FIG. 5, a user starts the process by selecting a dream (step 300). The “dream” that the user selects relates, in one embodiment, to a goal or idea that the user wants to achieve. For example, in one embodiment, the user selects a dream from a predetermined set of dream paths that can include items such as “People” the user wants to be with, “Places” the user wants to be, “Things” the user wants to own, or “Things” the user wants to do. Each of these dream paths is, in one embodiment, associated with business logic and or business rules (see FIG. 4) that are executed during the method of FIG. 5. Of course, these dream paths are merely representative of the types of paths that could be provided in various embodiments of the invention. In one embodiment, users are not required to complete all dream paths, although completion of all dream paths may generate more meaningful results in step 330 (costing the dream) and step 340 (planning for the dream).

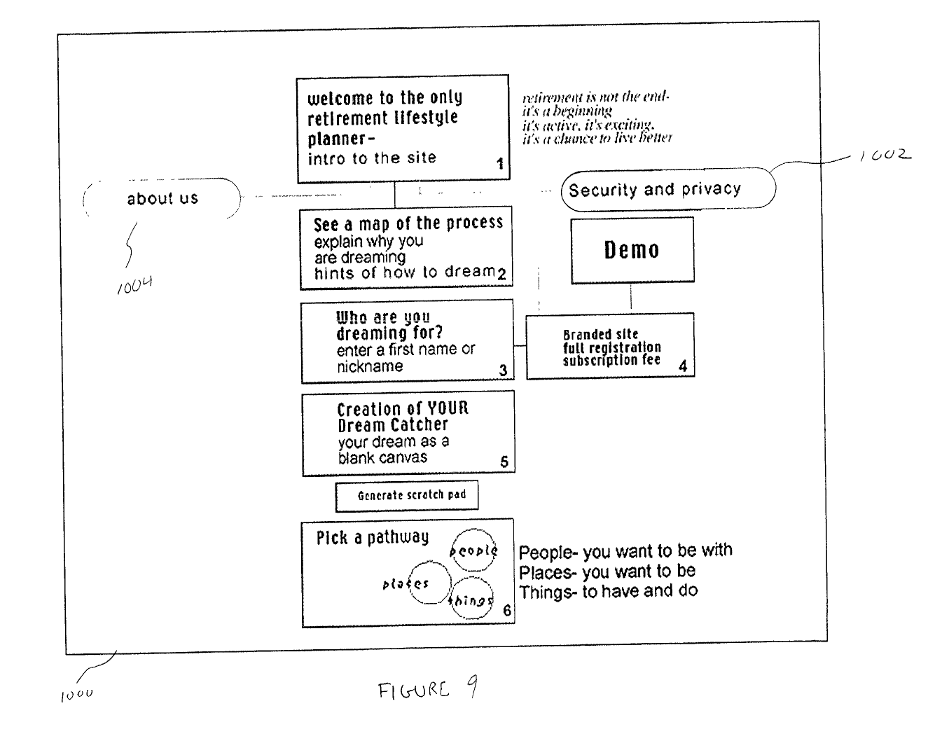

A representative example of the options that can be presented to a user in step 300 is shown in the screen shots of FIGS. 9-21, which have been implemented in accordance with embodiments of the invention.

FIG. 9 is a screen shot depicting an example welcome screen 1000 constructed in accordance with an embodiment of the invention. The welcome screen 1000 illustrates the initial navigation for a visitor to the web site. The welcome screen 1000 is an entry point to a system implemented in accordance with an embodiment of the invention and includes security and privacy information 1002, 1004. In one embodiment, the welcome screen 1000 also provides corporate background information 1004 about the entity responsible for maintaining or supporting the site. In accordance with one embodiment, screen shots such as that shown in FIG. 9 are designed to be an intuitive way for the user to navigate the methods of the invention, such as the method of FIG. 5. In one embodiment, the screen shots use rich media visuals and mouse-enabled forms, which may minimize the keyboard strokes required to utilize the application.

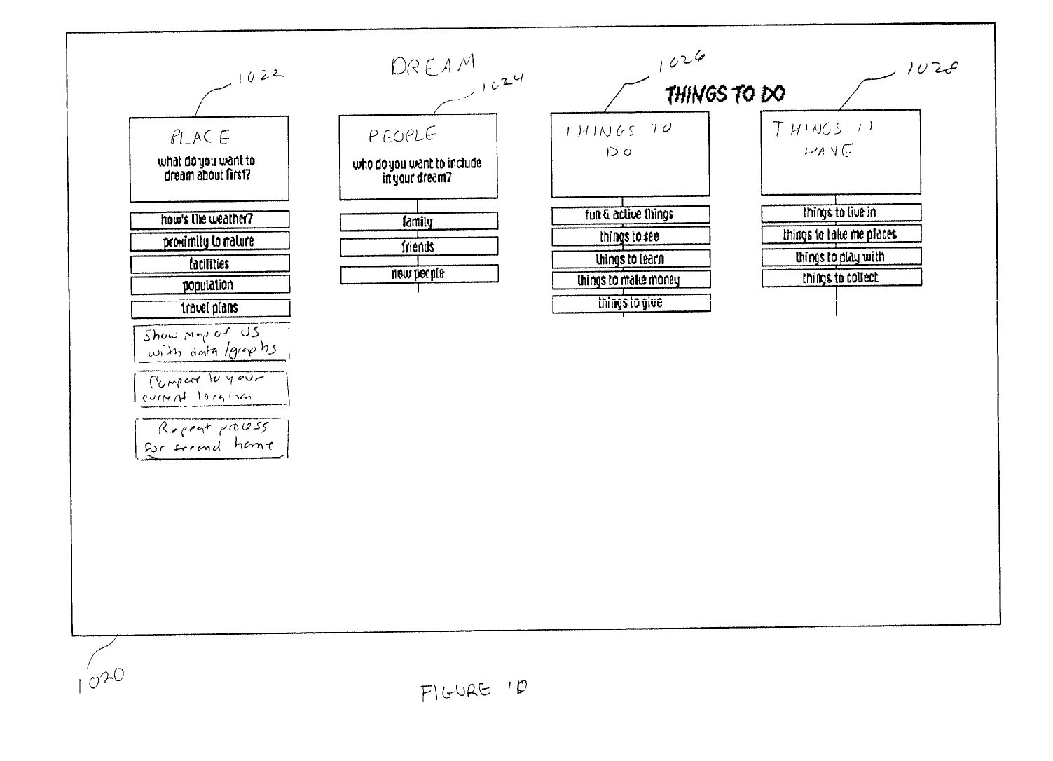

FIG. 10 is a screen shot depicting in example pathway navigation screen 1020 constructed in accordance with an embodiment of the invention. Navigation of the system of the invention, in accordance with one embodiment, follows a structured format invisible to the user 110. For example, functional areas of the screen are divided into pathways whose effective “nav map” is determined by embedded system business rules. User information is carried across pathways and is utilized by the business logic. Textual content explains the process and the expected time to complete each section. F or example, navigation allows for options such as “come back later,” “skip this area,” and “proceed.”

Referring to FIGS. 9 and 10, “Places,” “People,” “Things to do,” and “Things to have” are pathways for the systems and methods of at least one embodiment of the invention. Selecting from those four options is, in one embodiment, the initial step taken by a visitor to the web site in creating a profile for the visitor's lifestyle plan. It is not necessary for a user to complete all pathways, although, in one embodiment, it is advantageous for a user to complete all pathways to create a full profile that generates more meaningful results, particularly in the Cost and Plan portions.

In one embodiment of the invention, the selection of a path operates in accordance with one or more of the following rules (which can, for example, be implemented in the business logic 160 of FIG. 4):

Rule 1: Once a pathway is entered, it can be completed, skipped, or returned to later. “Skipped” means that the system will not suggest it again, unless the user 110 does not complete one of the other pathways.

Rule 2: New users complete at least one pathway per dream before COST, PLAN, and EXPLORE functions are accessible. The user 110 will be prompted to complete other pathways, and will have the option to skip them.

Rule 3: Users who exit and save their dream are returned, upon re-entry, to their dream page and are prompted to complete any incomplete pathways.

Referring again to FIG. 10, the pathway navigation screen 1020 depicts detailed pathway navigation for the Dream function for paths such as Places 1022, People 1024, Things to do 1026 and Things to have 1028. The user selects one of the four pathways and, in response to queries posed by independent statements, declares, interests and preferences relative to that pathway. When the user completes a pathway, the user can move on to another pathway.

For example, the People path 1024 includes topics, such as “family,” “friends,” and “new people,” that help determine line items for budgeting and exploring. In another example, the Things to do path 1026 Things to have path 28 each includes topics that also help to determine line items for budgeting and exploring, and provides suggestive sorting of large lists.

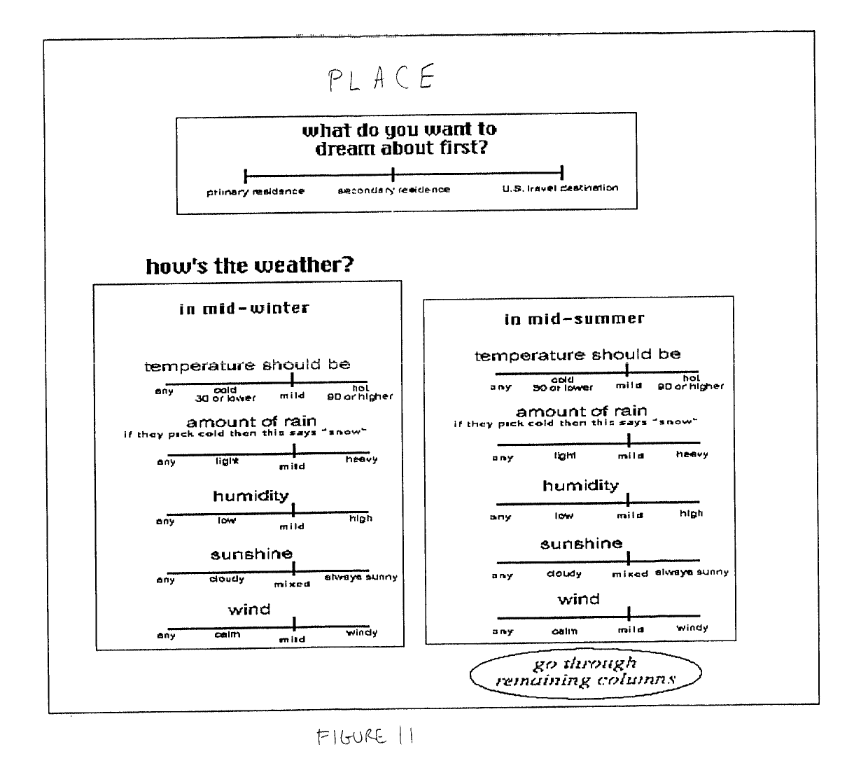

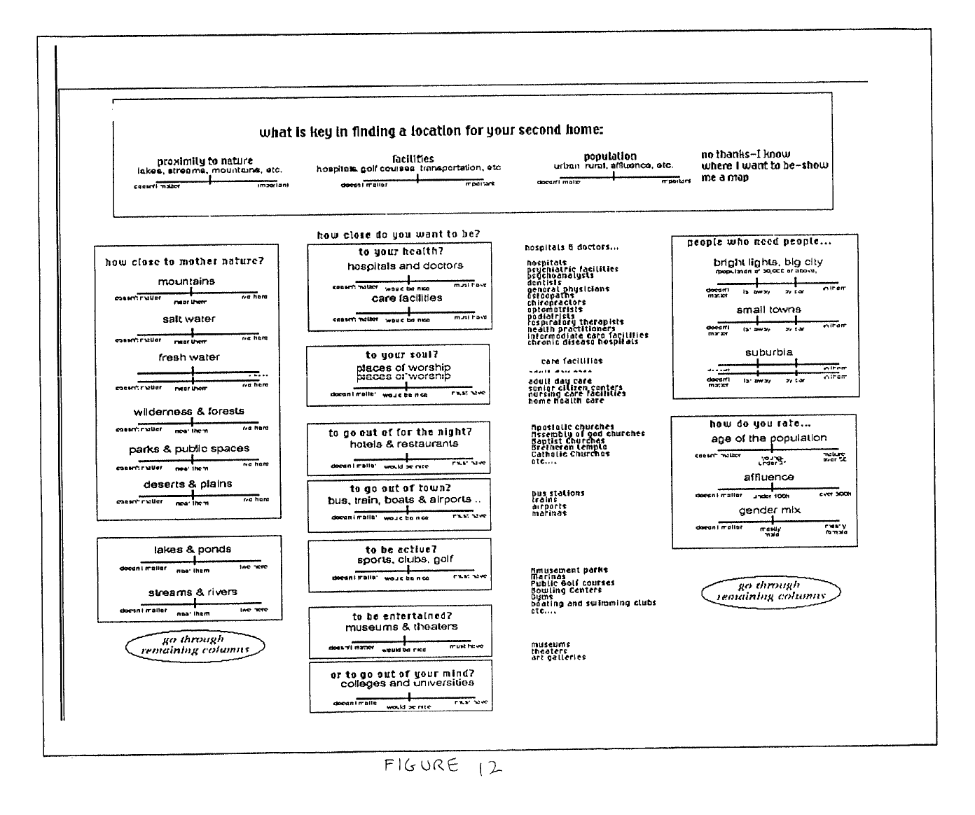

FIG. 11 is a screen shot depicting a first place navigation screen for the “Place” pathway 1022 of FIG. 10, in accordance with an embodiment of the invention. In the Place pathway 1022, the user (or other visitor to the system) is prompted to provide preferences relative to weather as it pertains his or her residence selection or travel desires. In the screen shot of FIG. 12, for the purposes of example, the user has selected a second home to be a preference.

Referring briefly to FIG. 5, based on the dream selected in step 300, the user is provided with one or more questions relating to the dream (step 310). These questions are, in one embodiment of the invention, designed to elicit from the user information necessary to help the user focus more squarely on the realities of the user's dream. In one embodiment, the questions may be sorted by category, as shown in the representative screen shot 1020 of FIG. 10. In one embodiment, the queries provided to the user are stored in one or more databases, such as content databases 190 (FIG. 4), and are provided in accordance with rules used by a business logic processing system 160 (FIG. 4).

FIGS. 11 and 12 are representative screen shots illustrating the types of queries that a user might receive when selecting a “Place” dream, in accordance with embodiments of the invention. Depending on the responses to the queries, the user may receive even more queries. For example, in the screen shot of FIG. 12, the user has selected a second home as a preference along with specifics regarding weather. Therefore, the Place pathway drills down to the next level of relevant inquires to enable and enhance the further development of the Place profile. More specific information may be requested to fill out this portion of the dream. The illustrated categories are not all inclusive, but they are representative.

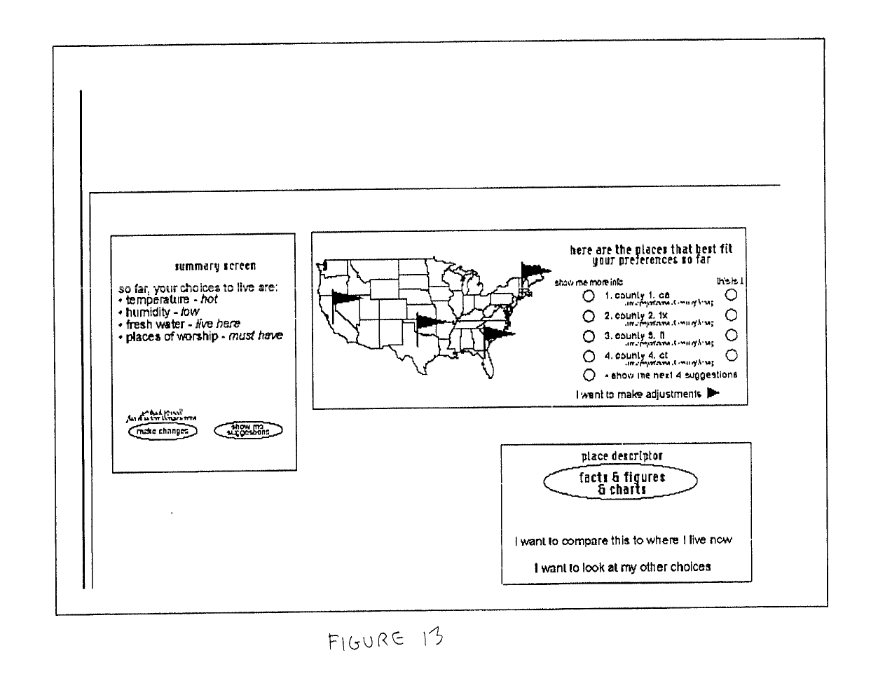

Referring again to FIG. 5, based on the responses to the queries to the user, the dream information is processed (step 320) to create a summary of the dream information. FIG. 13 is a representative screen shot depicting a representative place summary screen 1020for the “Place” pathway of FIGS. 11 and 12, in accordance with one embodiment of the invention. When the user has completed information relating to the user's preferences, the system provides the summary screen 1020, together with a map that highlights geographical areas that meet the preferences of the user. Facts, figures, and charts are provided to assist in comparisons of highlighted options. Users can compare their preference matches with their current address and region. Adjustment to selections can be made at anytime. In one embodiment, use of the summary screen 1020 and the information therein is iterative, with ongoing feedback to the user.

In one embodiment (not illustrated in FIG. 5), after the dream information is processed in step 320, the user may be given several options:

(1) Go back to step 300 and select another dream pathway (e.g., if the user has first selected the “Places” pathway, the user may next want to go through the “People” pathway), which may include saving the current “dream” scenario:

(2) Save the existing dream scenario and returning to the method of FIG. 5 at a later time; and/or

(3) Develope a cost for the dream created so far (i.e., moving to step 330 and beyond).

If the user chooses option (1) above, the user may select and provide information on other aspects of their dream (e.g., the other dream pathways, such as “People,” “Things to Do,” and/or “Things to Have”, as illustrated in the screen shots of FIGS. 9 and 10.)

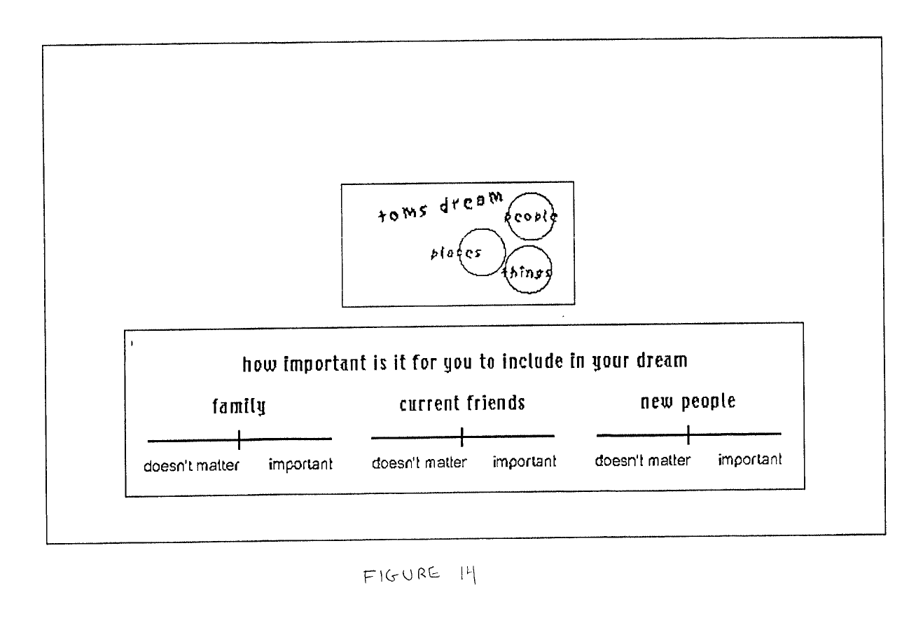

In one example, if the user selects the “People” pathway, the user is prompted to respond to iterative queries designed to allow the user to make declarations regarding people that are important to them. FIG. 14 is a screen shot depicting an example navigation screen for the “People” pathway of FIG. 10, in accordance with one embodiment of the invention, which shows how a user may be prompted to indicate the importance of various people in his or her life. The user also can be presented with specific inquires regarding family.

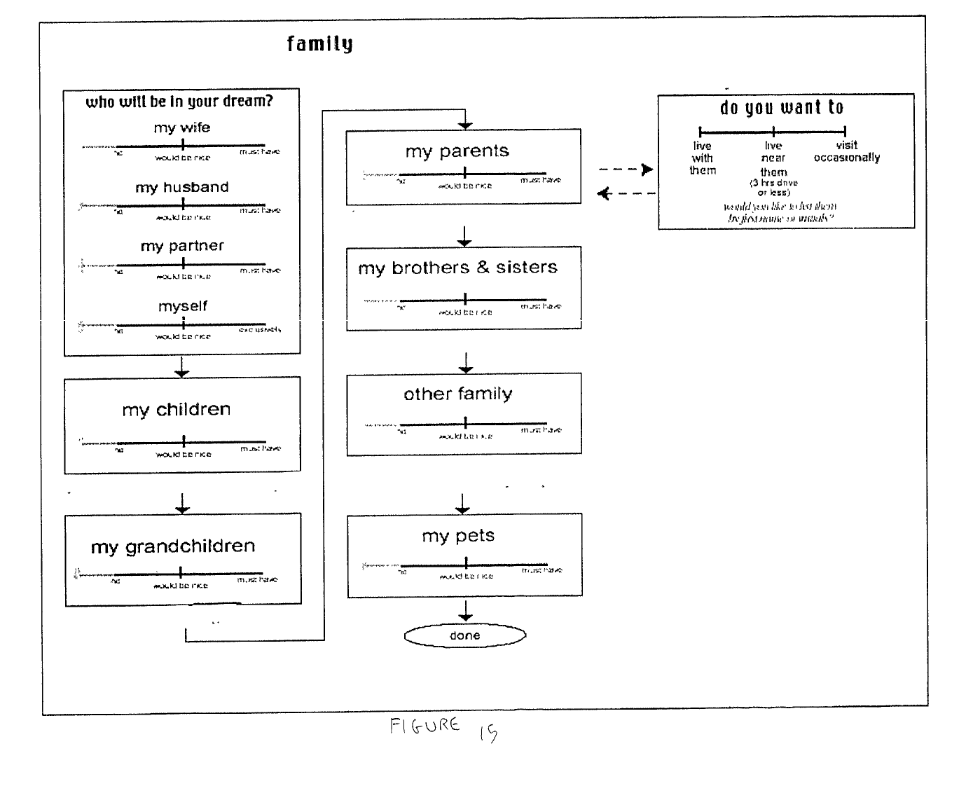

FIG. 15 is a screen shot depicting another example navigation screen for the “People” pathway of FIG. 10, in accordance with one embodiment of the invention, showing representative examples of additional queries. Some areas of the screen shot of FIG. 15 can be “drilldown” areas to prompt the user to provide additional specific and relevant information. For example, a Children: rating of 5 or greater on a scale of 1 to 10 generates additional questions that ultimately could impact the costing and planning steps of FIG. 5.

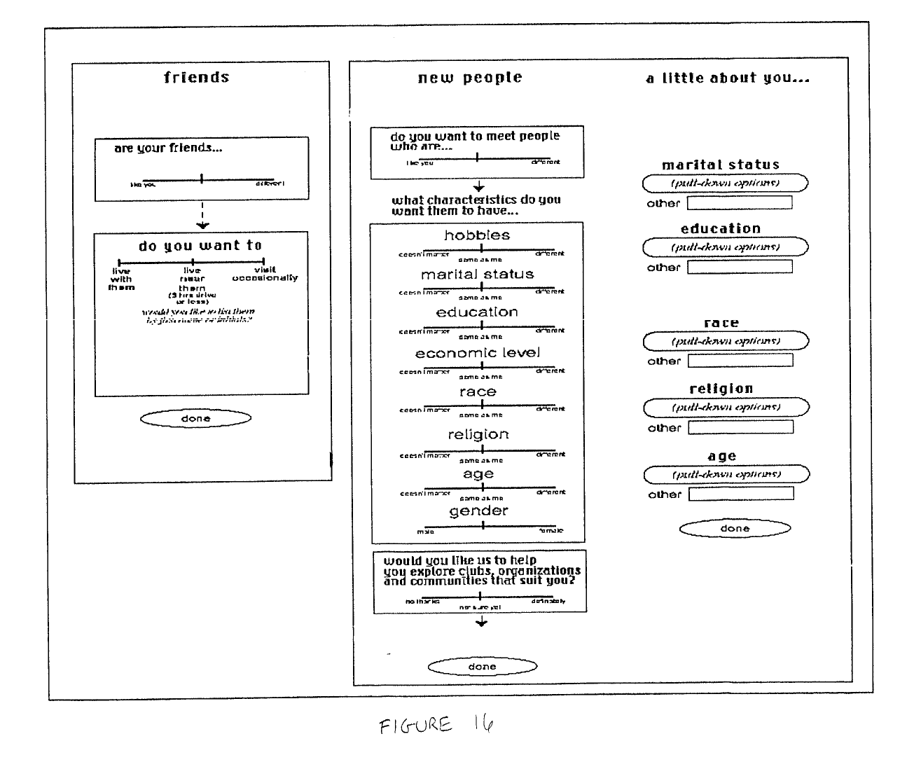

FIG. 16 is a screen shot depicting still another example navigation screen for the “People” pathway of FIG. 10, in accordance with one embodiment of the invention. This screen shot outlines additional pathways that, in one embodiment of the invention, are provided within the “People” pathway, such as the Friends, New People and Personal Options pathways. These pathways follow similar drilldown detail to that of the Family pathway.

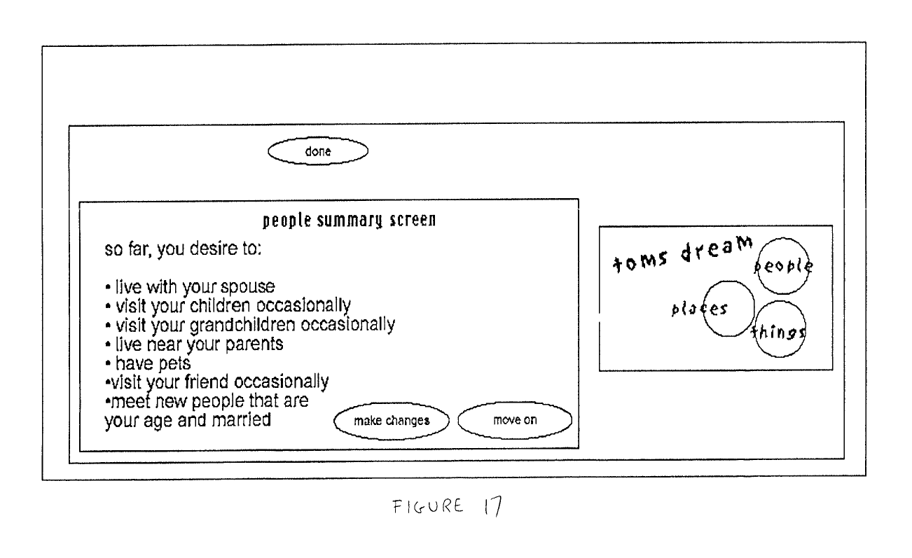

As with the “Places” pathway, the dream information for the “People” pathway is processed (step 320) to create a summary of the dream information. FIG. 17 is a screen shot depicting a summary screen for the “People” pathway of FIG. 10, in accordance with one embodiment of the invention. This screen summarizes all selections made in the People pathway.

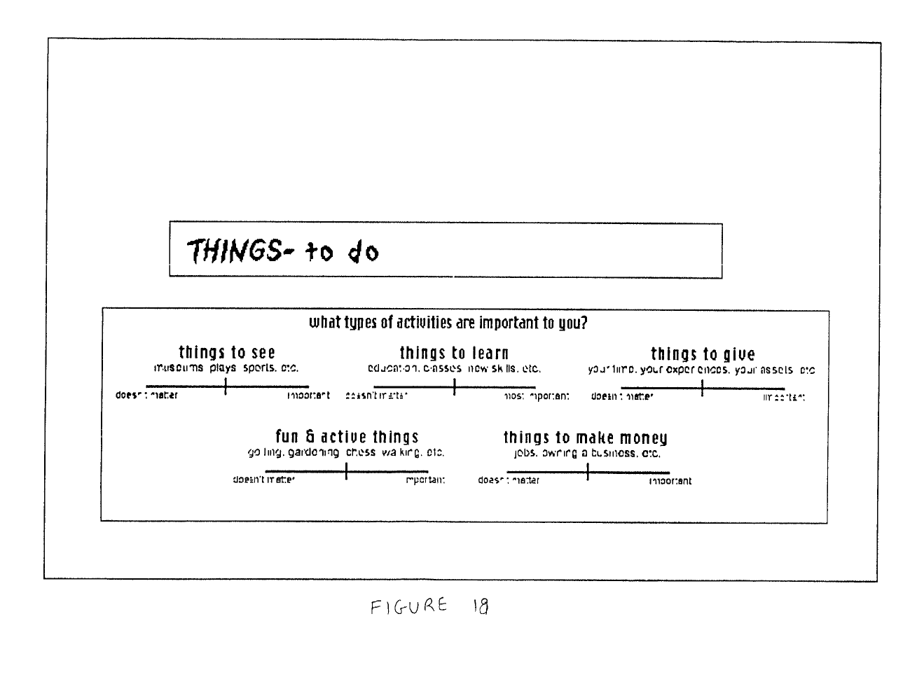

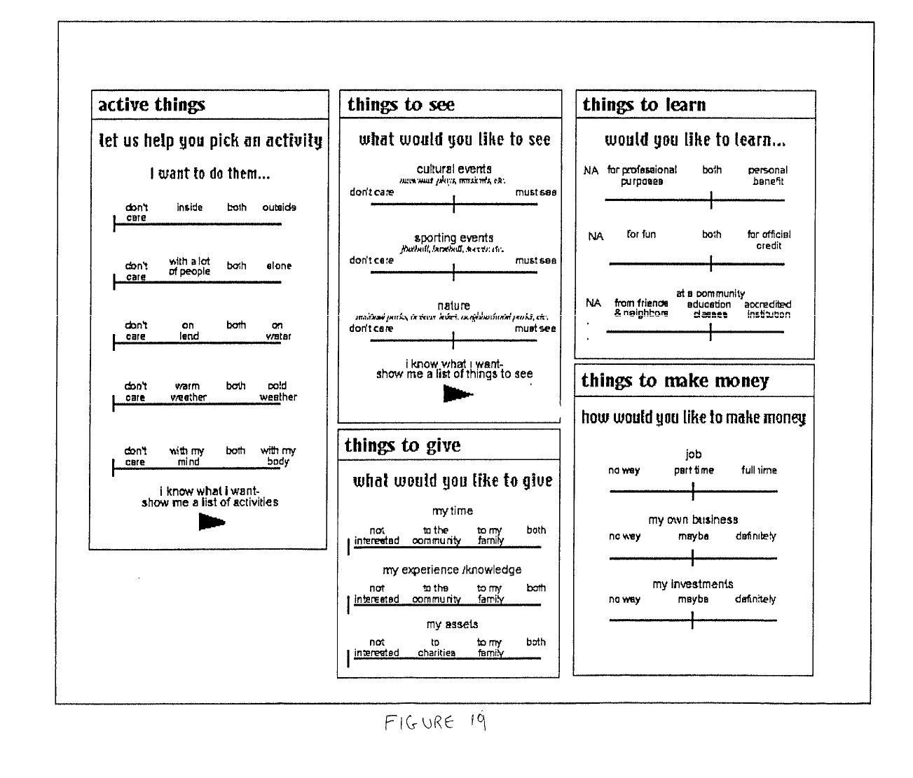

In another example, if the user selects the “Things to do” pathway at step 300 of FIG. 5, the user is prompted to respond to iterative queries designed to allow the user to declare the activities that are important to him. FIG. 18 is a screen shot depicting an example navigation screen for the “Things to do” pathway of FIG. 10, in accordance with one embodiment of the invention. FIG. 19 is a screen shot depicting another example navigation screen for the “Things to do” pathway of FIG. 10, in accordance with one embodiment of the invention. In FIG. 19, the preferences of the user are sought after to build a profile of the items most important to the user. In one embodiment, the “Things to do” pathway includes searchable indexes to assist the user in the development of his “Things to do” pathway (e.g., see the text in the screen shot of FIG. 19 stating “I know what I want—show me a list of activities”).

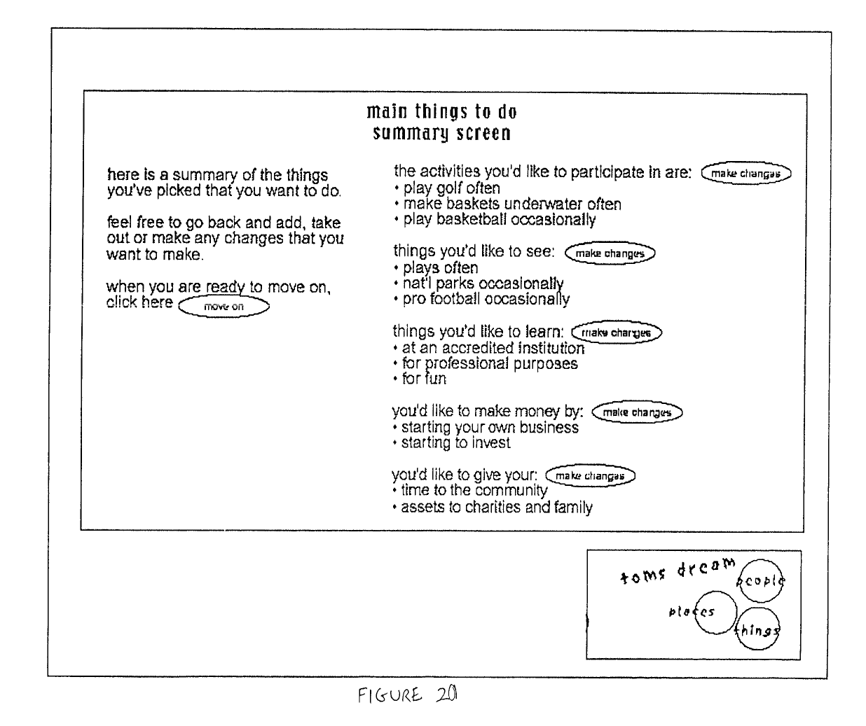

As with the “Places” and “People” pathways, the dream information for the “Things to do” pathway is processed (step 320) to create a summary of the dream information. FIG. 20 is a screen shot depicting an example summary screen for the “Things to do” pathway of FIG. 10, in accordance with one embodiment of the invention. The screen shot of FIG. 20 provides a summary page of all selections is provided in this section with an opportunity for the user to make changes if desired.

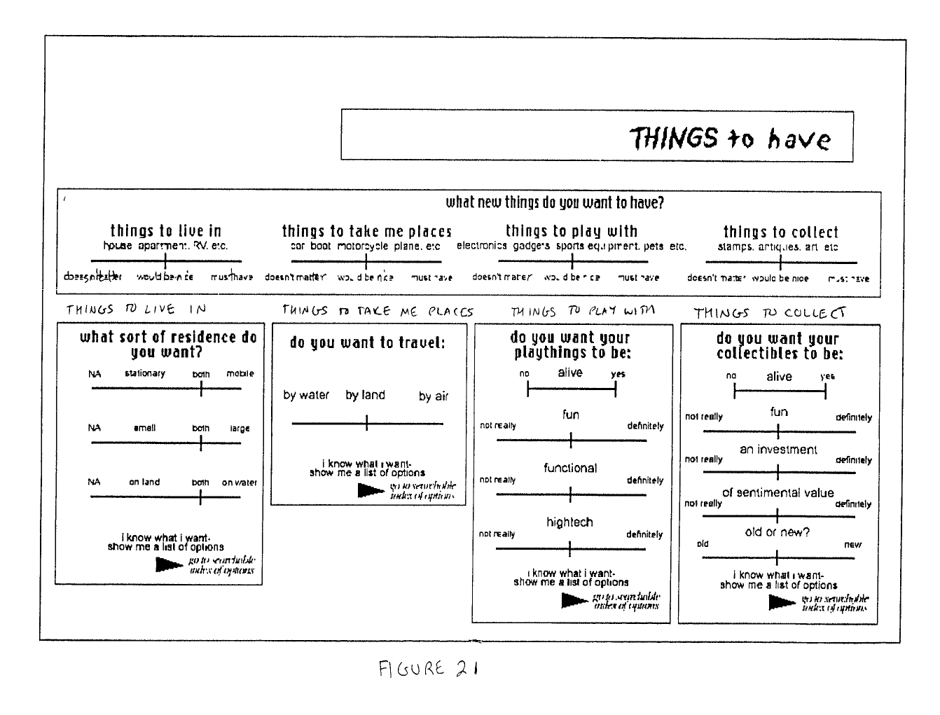

In still another example, if the user selects the “Things to have” pathway at step 300 of FIG. 5, the user is prompted to respond to iterative queries designed to allow the user to declare the activities that are important to him. FIG. 21 is a screen shot depicting an example navigation screen for the “Things to have” pathway of FIG. 10, in accordance with one embodiment of the invention. In the screen shot of FIG. 21, information is provided that relates to higher-level choices that may have been made by the user in preceding pathways. The user can add more specificity to their overall dream in this section.

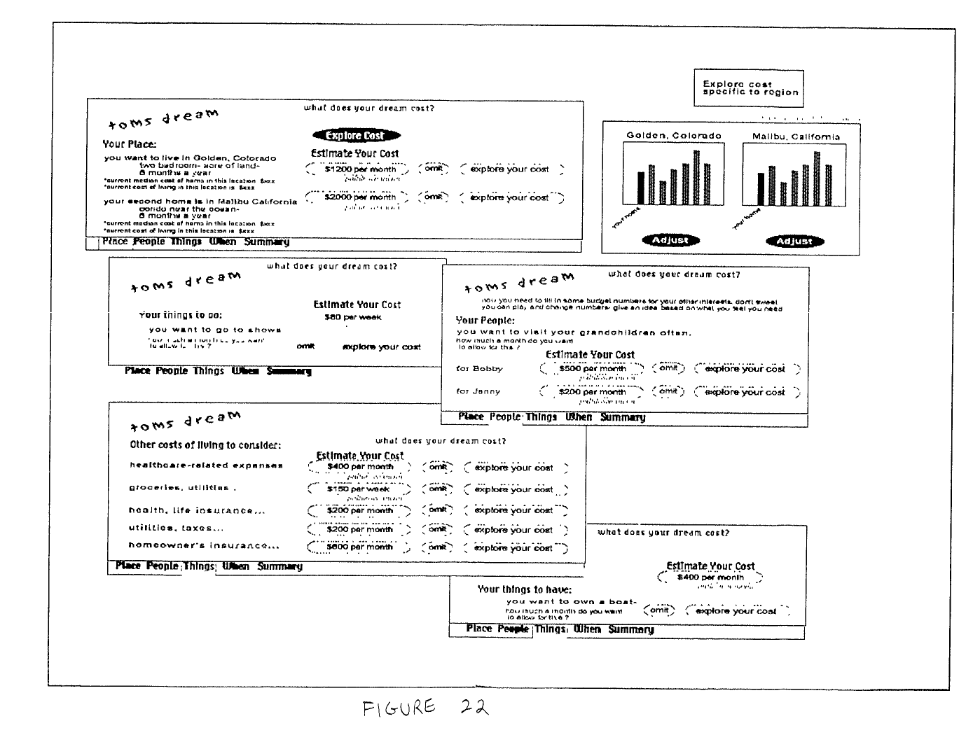

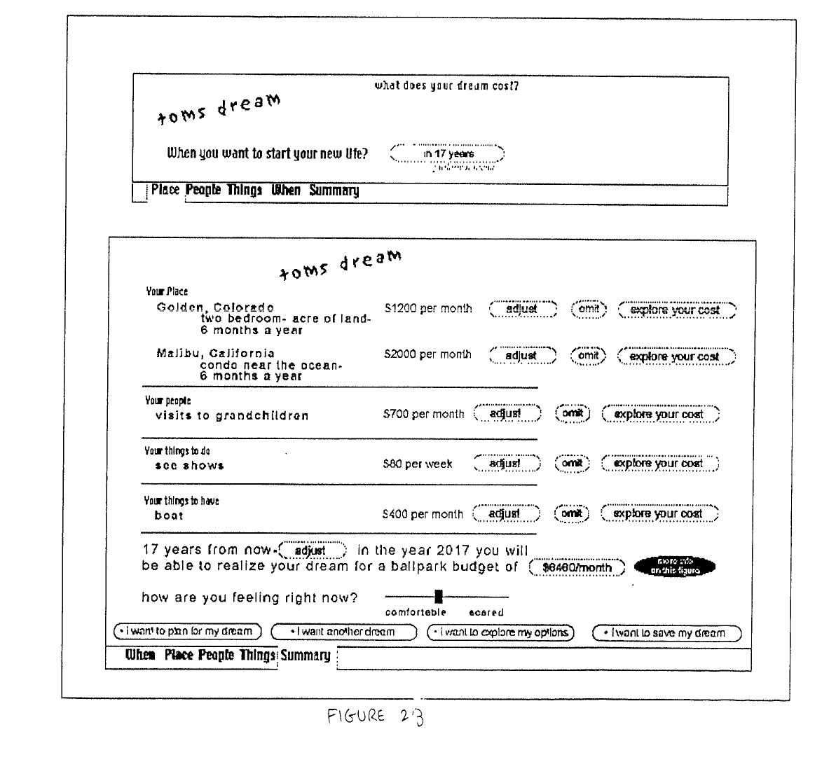

Referring again to FIG. 5, the cost for a dream, as selected and characterized by the user, is computed (step 330). FIGS. 22 and 23 are screen shots depicting example cost queries and a cost summary screen, respectively, for a “Dream” created in accordance with an embodiment of the invention. In this example, the user is provided with a high level estimate of costs associated with selections that the user made relating to his or her dream. In one embodiment, the cost screens enables user to view comparisons of costs associated with regions as selected by the user. In one embodiment, the user can drill down (i.e., get more information) on specific cost items.

FIG. 23 is a screen shot depicting another example of a summary screen for the costs of a “Dream” created in accordance with an embodiment of the invention. In this example, the user is provided with a summary of dream costs projected to selected milestones. The user may be prompted to pursue options in moving forward on planning (step 340 of FIG. 5), creating alternative dream scenarios (steps 300-330 of FIG. 5), exploring options (step 350of FIG. 5), or saving their work for future access.

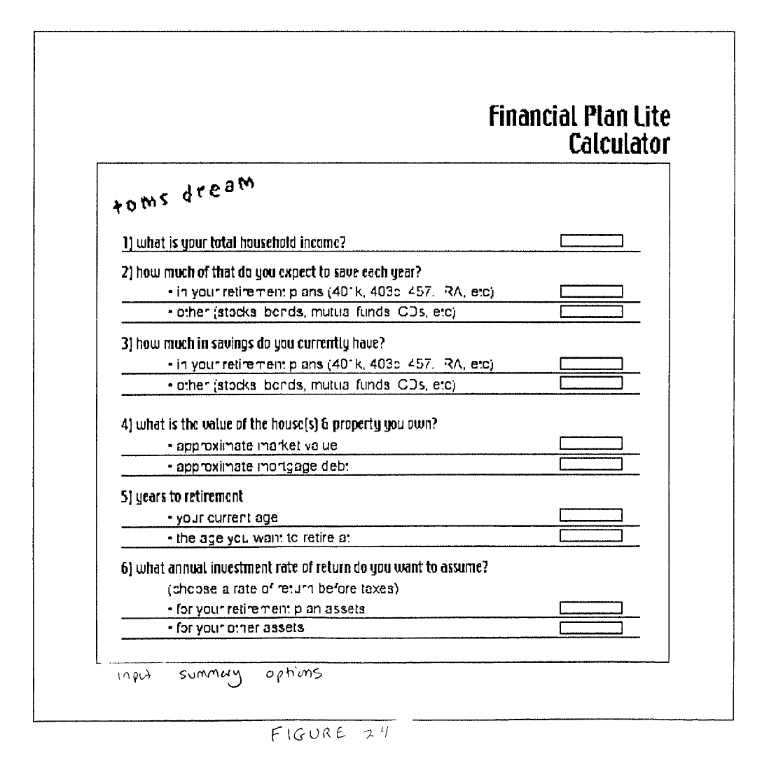

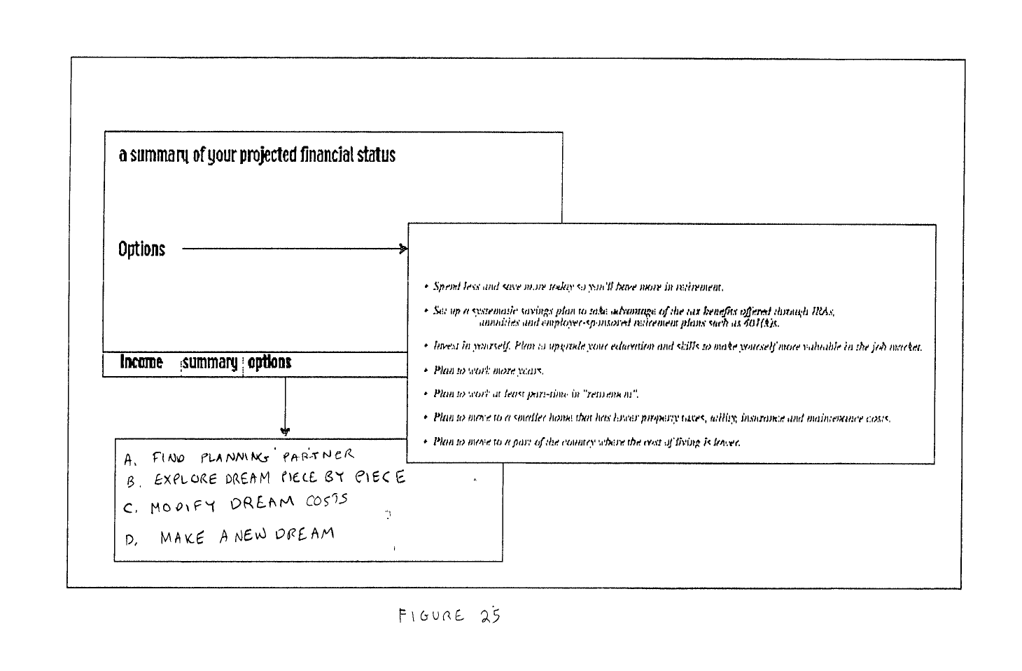

Referring again to FIG. 5, the plan for the dream is created (step 340). In one embodiment, the step of planning for the dream involves querying the user additionally for information (e.g., financial information) related to the dream being planned. FIGS. 24 and 25 are examples of screen shots depicting an example of a calculation tool screen, and associated queries, and a high level summary of costs, respectively, constructed in accordance with embodiments of the invention.

In FIG. 24, the example “Financial Plan Lite Calculator” that is displayed can, in one embodiment, be a “branded” financial calculator associated with a particular financial application (e.g., QUICKEN). In one embodiment, a “Financial Plan Lite Calculator” is provided as part of the dream planning application, which is useful if the method of FIG. 5 is used in connection with other applications that do not have access to a web based financial calculator. In one embodiment, the example “Financial Plan Lite Calculator” of FIG. 24 is interchangeable with financial planning applications that many financial service companies currently utilize. In one embodiment, to use the calculator, the user fills in the required data. In another embodiment, the financial data is available from a user's financial application or a user's service company.

FIG. 25 is a screen shot depicting a summary screen for projected financial status, created in accordance with an embodiment of the invention. This screen provides a high level summary of costs as compared to the assets of the user. Options are highlighted for the user to choose from to accomplish their final objective. In one embodiment, the user may seek assistance in this section from their financial service company to help them achieve their dreams.

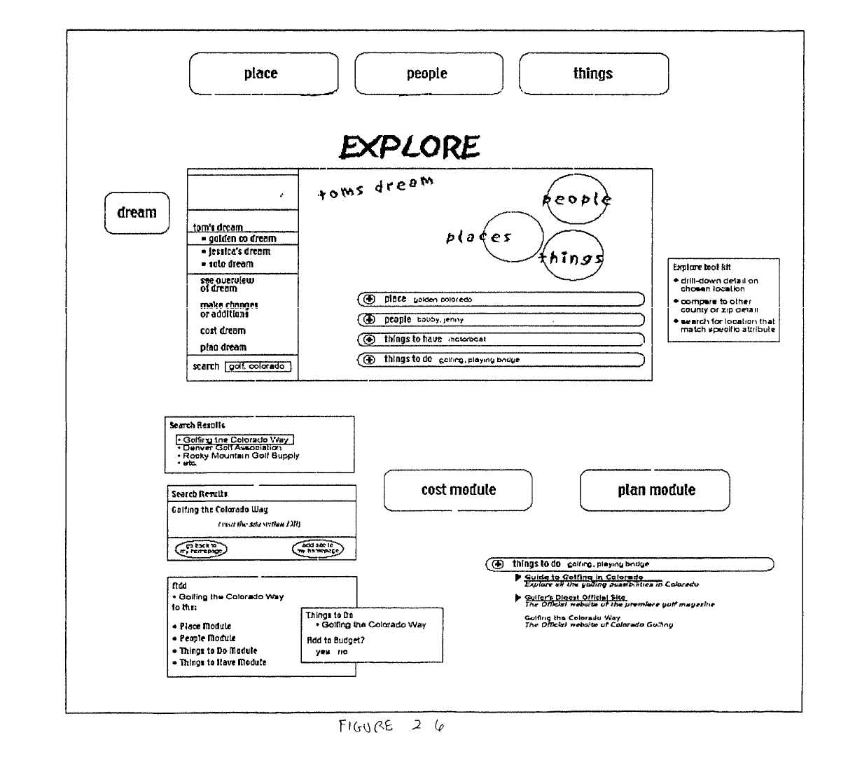

Referring once again to FIG. 5, in some embodiments of the invention, the user will be able to more fully explore the dream he has selected (step 350). In the exploring step, the user explores specific areas of interest in detail that are related to their dream(s). In one embodiment, the user can fulfill aspects of his dream either directly or via permission marketing opportunities made available though one or more partners 120(see FIG. 4) associated with the systems and methods of the invention. FIGS. 26-28 are screen shots depicting examples of “Explore” screens created in accordance with embodiments of the invention.

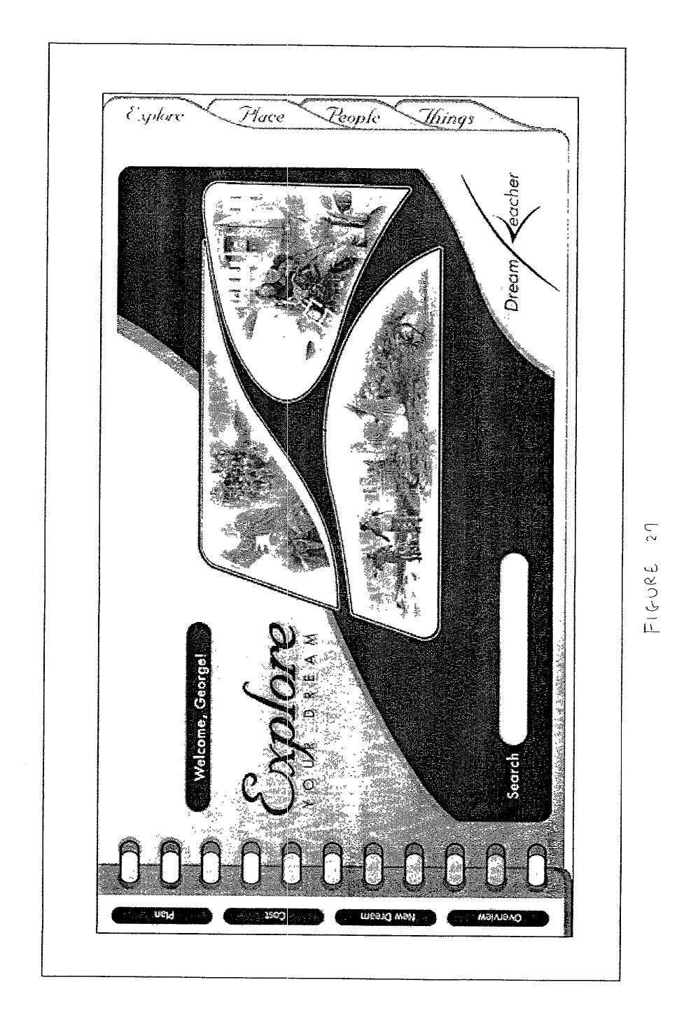

FIG. 27 is a screen shot depicting an album of dream and financial information created in accordance with an embodiment of the invention. The screen shown in FIG. 27 enables user to have a highly visual experience. The user can page through the on-screen “album” as easily as reading a book or magazine that describes a “dream” lifestyle. Representations in the “album” are, in one embodiment, context sensitive and personalized based on the visitor's input. For example, if the user's dream is to retire to the Tarpon Springs on the Gulf Coast of Florida with his wife and dog, live in a new condo, and spend his days fly-fishing, the “album” could include pictures of the locale, information about boat rental and repair shops, maps showing new condo locations, names and addresses of veterinarians in the area, and so forth. Financial data, such as a month-by-month savings plan, with yearly goals and milestones, also may be included. In one embodiment, the user can upload his or her own pictures to the album.

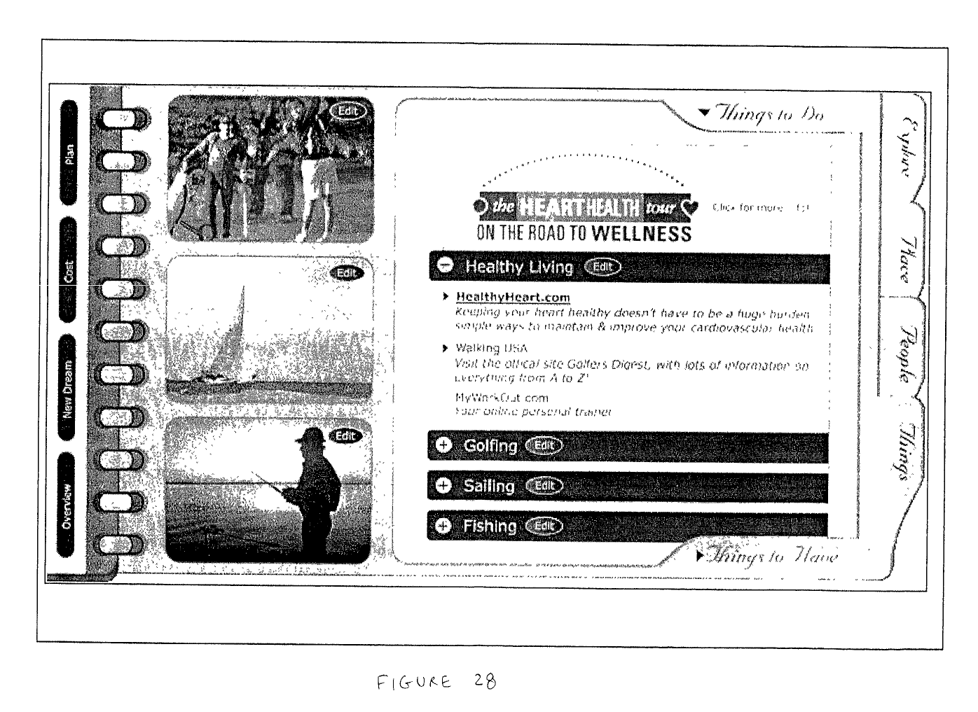

FIG. 28 is a screen shot depicting one of the pages in the album of FIG. 28.

In one embodiment of the invention, the actions associated with the “Explore” step of FIG. 5 include functions and screens providing a number of additional tools and features. For example, in one embodiment, the step of “exploring” includes using tools such as search engines, including a context sensitive search engine. The context sensitive search engine allows a user to enter in a simple search term and then, in performing the search, automatically takes into account (using, for example, Boolean strings and other approaches) other relevant aspects known about the user.

For example, a user who is interested in retiring to Arizona and whose projected retirement income exceeds $150,000 might enter the search term “golf country clubs” into the context sensitive search engine. The engine, by first examining known attributes of the user and his/her dream, would search for golf country clubs in Arizona that would be appropriate for upper income people. Similarly, a user entering the term “marinas” into this engine would receive results relative to southern Florida that can accommodate boats of greater than 40 feet in length if that additional information fits the known profile of the user.

The “explore” functionality also, in one embodiment, includes features such as bulletin boards and chat rooms. In another embodiment, the “explore” functionality includes community pages, which users can personalize to contain news items, articles, links and other content that relate to their dream(s) and which may be updated on a periodic basis. In one embodiment, these community pages are not “static” pages; the layout and content is tailored to both the customizing done by the user as well as by what is known about the user. For example, the lifestyle planning system 150 of FIG. 4 can maintain these community pages and provide the user knowledge to tailor them.

In one embodiment, the “explore” functionality also provides access to periodic webcasts. For example, those webcasts that are on topics especially relevant to a user's dream are highlighted on their community pages and/or in email alerts.

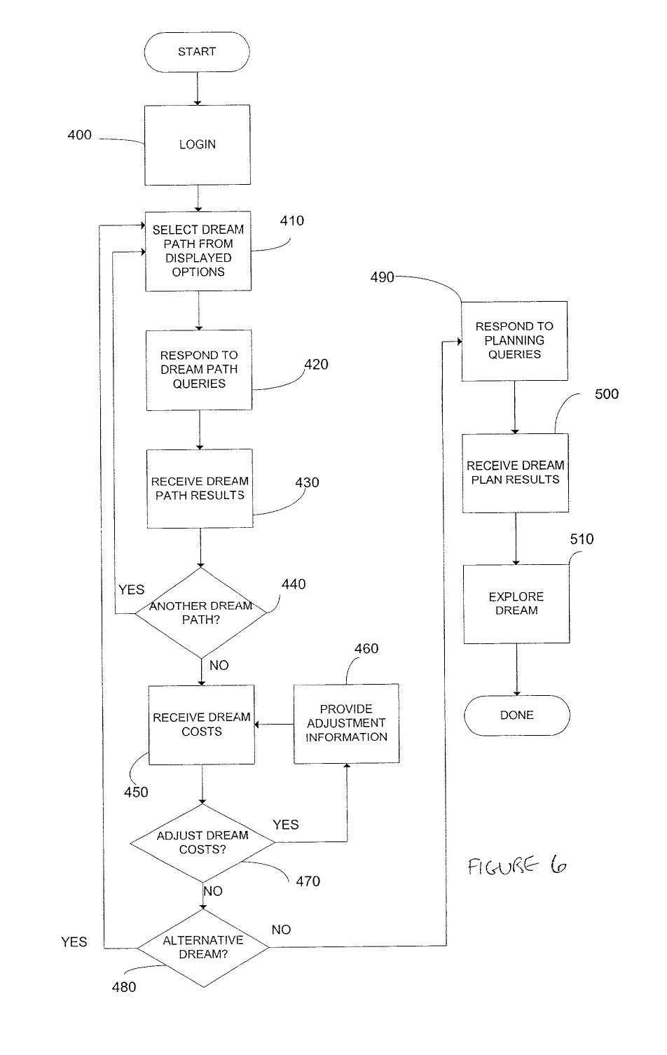

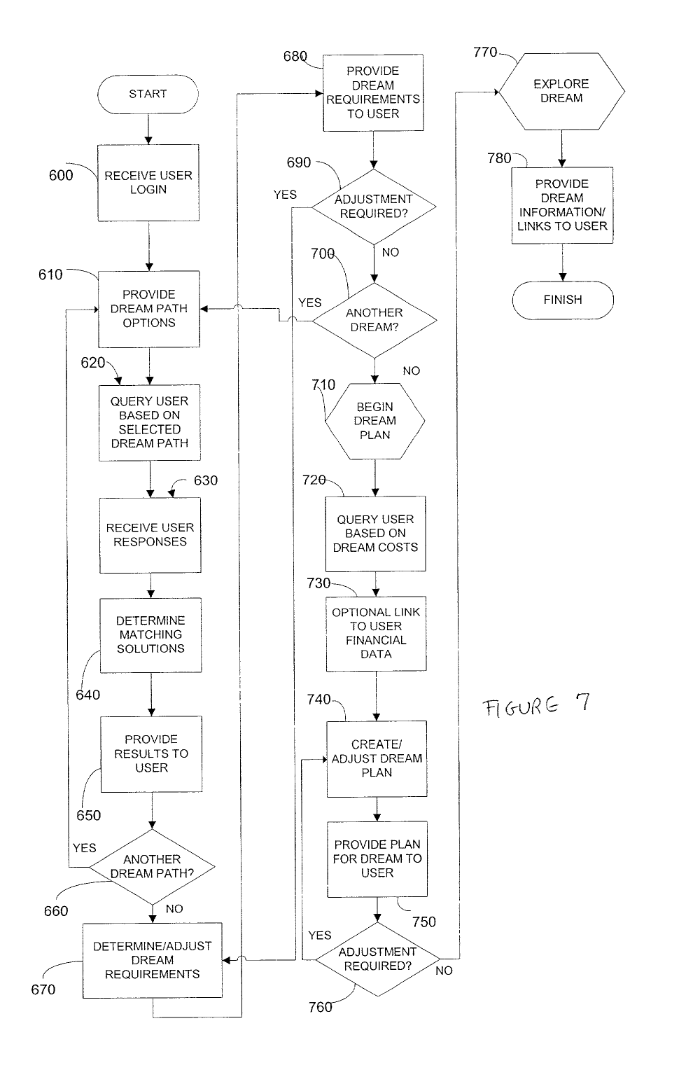

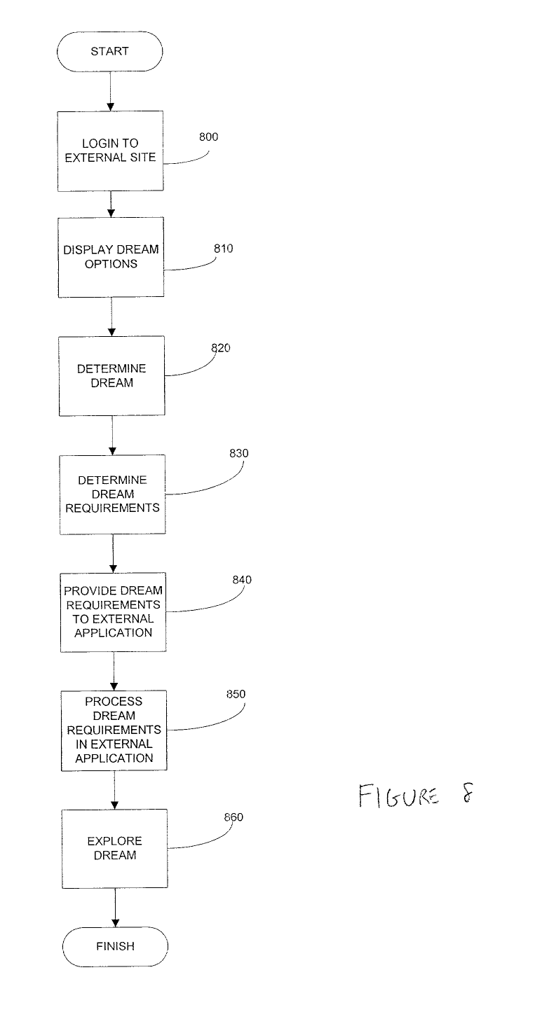

FIGS. 6, 7, and 8 are flow charts illustrating, in greater detail, the method for lifestyle planning of FIG. 5, in accordance with an embodiment of the invention. FIG. 6 is a flow chart illustrating a method for lifestyle planning, from the perspective of a client, in accordance with one embodiment of the invention. FIG. 7 is a flow chart illustrating a method for lifestyle planning, from the perspective of a server, in accordance with one embodiment of the invention. FIG. 8 is a flow chart illustrating a method for lifestyle planning using an external application for processing the dream cost information, in accordance with one embodiment of the invention;

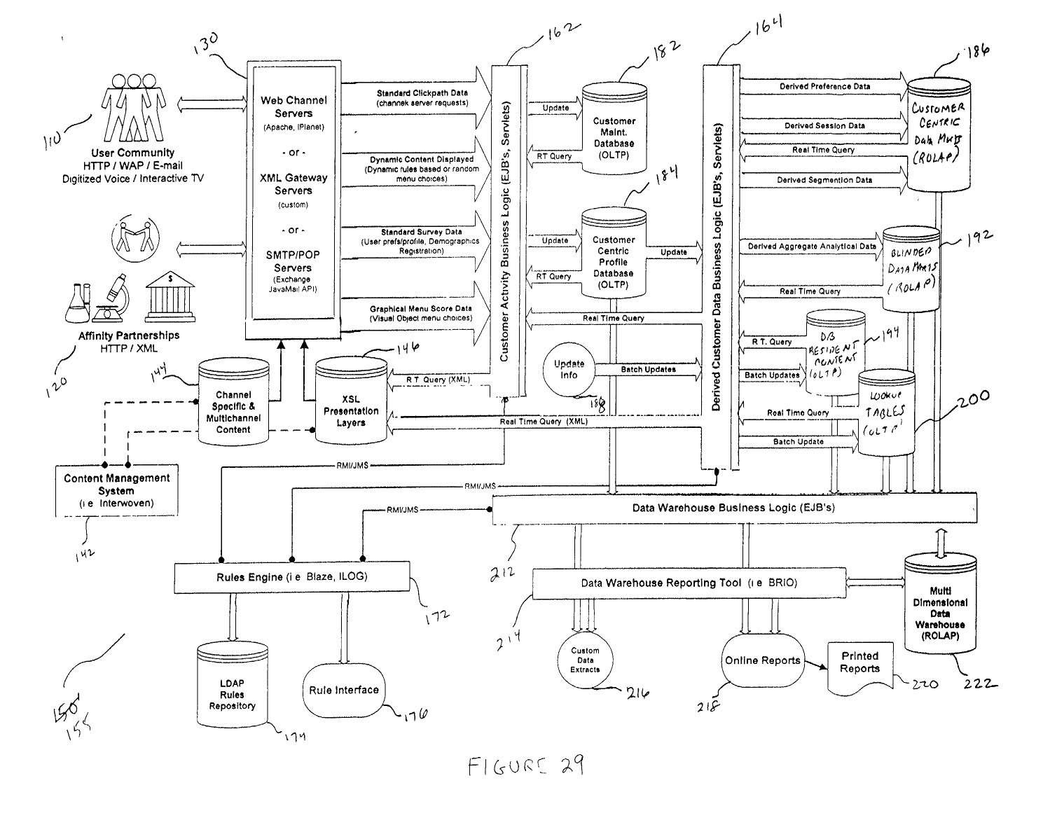

FIG. 29 is a system architecture 155 for a system implemented according to one embodiment of the invention. The system architecture 155 follows the functional breakdowns illustrated in the block diagram 100, of FIG. 4 and description of these functions is not repeated here.

In the system architecture 155 of FIG. 29, one or more users 110 interacts, via a web server 130, with a lifestyle management system that includes customer activity business logic 162, derived customer data business logic 164, a rules engine 172, an LDAP rules repository 174, a rule interface 176, a customer maintenance database 182, a customer centric profile database 184, a customer-centric data mart 186, a blinded data mart 192, database resident content 194, lookup tables 200, data warehouse business logic 212, a data warehouse reporting tool 214, and a multi-dimensional data warehouse 222. One input to this lifestyle management system includes update information 188, and outputs of the lifestyle management system of this embodiment include custom data extracts 216, online reports 218, and printed reports 220. Any one or more of the outputs may be provided to a user 110 and/or a partner 120.

The aforementioned lifestyle management system also interacts with a content presentation system that includes a content management system 142, a database of channel specific and multichannel content 144, and one or more XSL presentation layers. The types of content stored in the database 144 are, in one embodiment, provided to a user in accordance with the type of channel by which a user communicates. For example, the user 110 may receive certain content if the user 110 is communicating using a protocol such as WAP, a different message if the user is using a direct mail protocol, and so on.

The web server 130 sends one or more of the following types of information to the customer activity business logic 162: standard clickpath data (such as channel server requests), standard survey data (such as user preferences, user profile, demographic information, registration information), graphical menu score data (including visual object menu choices), and displayed dynamic content (such as content selected by the user 110) provided in accordance with a set of dynamic rules or by random menu choices of the user 110. Graphical menu score data is, in one embodiment, the results of the graphical preference choices that are presented 5throughout the dreaming process. For example, if the user is presented with climate choices, the user moves a slider rather than check a text box. In some instances, the user may be presented with several graphics to choose from to best represent, for example, the type of house they envision living in. Standard survey data refers, in one embodiment, to the declarations (typically made early in the dream process) that the user makes about how he wants his experience on the site to work, who can have access to the dream, basic info about who he is, etc., and displayed dynamic content (such as content selected by the user) provided in accordance with a set of dynamic rules or by random menu choices of the user.

The customer activity business logic 152, in one embodiment of the invention, responds to information and/or data that are provided to it in accordance with one or more rules implemented using the rules engine 172. In one embodiment, in response to receiving information such as clickpath data and/or channel server requests, from the web server 130, the customer activity business logic 162, in one embodiment, sends one or more real time queries to the XSL presentation layers 146, which interact with the content management system 142 and the channel specific and multichannel content database 144 to provide responses to the requests. These responses are provided to the web server 130 by the XSL presentation layers 146 and/or the channel specific and multichannel content database 144.

In response to receiving survey data from the web server 130, graphical menu score data, and/or dynamic content that is displayed (e.g., requested for display by the user), the customer activity business logic 162 provides updates to one or more customer databases, such as the customer maintenance database 182 and/or the customer centric profile database 184. In response, either or both of these databases may, in accordance with their respective transaction processing protocols, provide the customer activity business logic with one or more real time query responses, which are then provided to the user 110 via the XSL presentation layer 146. In addition, in one embodiment, the customer centric profile database 184 provides update information to the derived customer data business logic 164, which then provides this information to any one or more of the customer centric data marts 186, the blinded data marts 192, the database resident content 194, and/or the lookup tables 200. Any one or more of these databases my respond with a query data response for the user.

In one embodiment, the queries are posed to a database or a session layer (e.g., EJB's) that contains cached data that may or may not have actually hit the database yet. Thus, in one embodiment, there are multiple sources of data housed in multiple locations, all of which can be accessed in real time to develop highly personalized, dynamic content. The responses from the databases (e.g., the customer maintenance database 182, the customer centric profile database 184, the customer centric data mart 186, the blinded data marts 192, the database resident content 194, the lookup tables 200, and/or the multi-dimensional data warehouse 222) flow through the XSL presentation layers 146 (which, it should be noted, may comprise a single XSL presentation layer 146) to be formatted for the proper presentation channel (email, web, etc) for the user 110.

The standard survey data sent from the web server 130 to the customer activity business logic 162 is, in one embodiment, provided as an update to the customer centric profile database 184. The customer centric profile database 184 provides the standard survey data (in the form of an update from the customer centric profile database 184) to the customer centric data marts 186. In one embodiment, the derived customer data business logic uses one or more rules implemented in the rules engine 172 to provide the standard survey data (update) in the form of derived preference data, derived session data, and derived segmentation data. As discussed previously, in one embodiment, derived data can be “scored” data or other data that has been classified in some manner, such as that provided in the lookup tables 200. Another example of derived segmentation data, in accordance with one embodiment of the invention, is the storage of data such as the total number of times a user visits a web site implementing the invention, conclusions about the user based on the users responses to survey questions, e.g. “If you live in Greenwich, Conn. there is a high propensity that you make more than 100,000 K/yr”. In response, the customer centric data marts 186 may provide one or more real time queries to the derived customer data business logic 164, which are then provided to the user 110 via the XSL presentation layer.

In response to receiving dynamic content messages, the customer activity business logic 162 provides the information to the customer centric profile database 184 in the form of an update, which is received at the derived customer data business logic 164 and then provided to the database resident content 194 in the form of one or more batch updates. In response, the database resident content 194 can submit a real time query to the derived customer data business logic 164, which then transmits the query response to the XSL presentation layer 146, in accordance with one or more rules implemented at the rules engine 172, for forwarding to the user 110.

As noted previously, updated information 188 can be provided to the system architecture 155 in the form of batch updates of data that are sent to the derived customer data business logic 164, which then provides the information 188 in the form of batch updates to the lookup tables 200. In response, the lookup tables 200 may provide real time queries to the derived customer data business logic 164, which can provide the queries to the user 110, via the XSL presentation layer 146, in accordance with one or more rules implemented by the rules engine 172.

The aforementioned information (standard clickpath data, dynamic content, standard survey data, and/or graphical menu score data) may also, in one embodiment, be provided to the data warehouse business logic 212 via one or more updates sent to the customer centric profile database 184. The data warehouse business logic 212 communicates this information to the data warehouse reporting tool 214 so that it can prepare, as needed, custom data extracts 216, online reports 218, and/or printed reports 220. In addition, the data warehouse business logic 212 can, in one embodiment, communicate this in formation to the multi-dimensional data warehouse 222. Further, the data warehouse business logic 212 also can provide information from the customer centric data mart 186, the blinded data mart 192, the database resident content 194, and/or the lookup tables 200, to the multi-dimensional data warehouse.

The customer maintenance database 182, in one embodiment, contains information such as user name, address, login info, user level lockout, and the like.

The customer centric profile database 184, in one embodiment, contains information such as user specific transactional info that relates to questions answered by the user, e.g. “Do you want to learn to play golf ?”

The customer centric datamarts 186, in one embodiment, contain information such as user specific information derived from transaction record data. Business logic is applied to the data and either assumptions are made to create marketing data objects, or math is applied to the transactions to derive statistics. Data is still stored in a transaction format. For example: a data item is created based on the fact that a clickstream analysis was done on a user's previous three visits to the web site and it has been determined that the user is a prime candidate to purchase a summer home in Florida (even though the user had never been asked that question).

The blinded datamarts 192, in one embodiment, contain information similar to that stored in the customer centric datamarts 186, but the data is stored anonymously and may reflect cross sections of individual users (composite views). For example, the blinded datamarts 192 may include information such that 10% of the users who live in the New York/New Jersey/Connecticut area (“tri-state area”) are a prime candidates to purchase a summer home in Florida.

The database resident content 194, in one embodiment, includes HTML, graphics, PDF's, etc. that are stored in the database as opposed to being stored in a flat file system.

The lookup tables 200, in one embodiment, contain charts, graphs, tables, etc. that represent either additional content data or alternate views of content data than the views of it provided by the database resident content 194.The lookup tables may facilitate quick response to lookup-type queries (e.g., how many houses are there in Roxbury, Mass. that have a market value between $200,000 and $250,000).

The multidimensional data warehouse 222, in one embodiment, stores a ROLAP version of the transactional and datamart data described above, with additional layers of derived data that are representative of an analytical view of the database as a whole. The multidimensional data warehouse 222 also may be referred to as “Precompiled statistics to the N'th degree.”

As described herein, those skilled in the art will appreciate that, some embodiments of the present invention may overcome the significant shortcomings of prior art systems and methods and provide a computerized lifestyle and retirement planning system and method which takes a user's wishes, needs and goals into consideration in identifying a recommended investment or savings plan.

It should be understood that, in the Figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art will recognize that the number of a particular system element or method steps can, in some instances, be selected to accommodate the particular user needs.

It also should be noted that the previous illustrations of screen shots, together with the accompanying descriptions, are provided by way of example only and are not limiting. Those skilled in the art will recognize that many different designs of interfaces, screen shots, navigation patterns, and the like, are within the spirit and scope of the invention.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed.

1. A computerized method for creating a customized lifestyle plan for a user, the method comprising:
identifying a user's desired lifestyle;
identifying at least one user preference associated with the desired lifestyle;
identifying financial information associated with the user;
determining the cost of the user's desired lifestyle, in accordance with the user preference determining whether the desired lifestyle is achievable with respect to the financial information; and,
providing a lifestyle plan associated with the desired lifestyle and the financial information to the user.

2. The method of claim 1 further comprising the step of sending a query to the user to identify at least one of the desired lifestyle, preference, and financial information.

3. The method of claim 1 wherein at least a portion of the method is performed using a computer network.

4. The method of claim 1, wherein the step of identifying a user's desired lifestyle further comprises identifying a user's desired retirement scenario.

5. The method of claim 1, wherein the step of identifying a user's desired lifestyle further comprises identifying at least one of the user's desired place to be, place to go, person to be with, thing to own, and thing to do.

6. The method of claim 1 wherein the step of determining the cost of the user's lifestyle further comprises the steps of:
determining a cost associated with each user preference;
summing the costs of each user preference to generate a total cost associated with the desired lifestyle;

7. The method of claim 1 wherein the step of determining whether the desired lifestyle is achievable comprises comparing the cost of the desired lifestyle to the financial information.

8. The method of claim 1 further comprising the step of providing the cost information to the user.

9. The method of claim 1, further comprising the step of presenting the user with a suggestion associated with at least one of the desired lifestyle and the financial information.

10. The method of claim 1 further comprising the step of advising the user to edit at least one of the desired lifestyle and the financial information.

11. The method of claim 10, further comprising the step of providing the user with the ability to edit at least one of the desired lifestyle and financial information.

12. The method of claim 1 wherein the step of identifying financial information associated with the user further comprises querying the user for financial information.

13. The method of claim 1 wherein the step of identifying financial information associated with the user further comprises retrieving the financial information from a location specified by the user.

14. The method of claim 13 wherein the step of retrieving the financial information further comprises retrieving the financial information from a third-party source.

15. The method of claim 1 further comprising the step of providing the user with the ability to obtain information about at least one aspect of the user's desired lifestyle.

16. A computerized system for generating a lifestyle plan for a user, said system comprising:
a converter receiving a first set of data responsive to inquiries designed to evoke responses indicative of a desired lifestyle that the user wishes to live, receiving a second set of data responsive to inquiries regarding the user's financial resources, and receiving a set of information based at least in part on the first and second sets of data, wherein the converter uses the set of information to generate a lifestyle plan;
a database in operable communication with the converter, the database retrieving a third set of data associated with the received first and second data; and
a summing junction in operable communication with the database, the summing junction comparing the first data to the second data depending upon said third data, and providing the results of the comparison to the converter.

17. The system of claim 16, wherein at least a portion of the third data is associated with a total cost of user preferences associated with the desired lifestyle.

18. A computerized lifestyle planning system, comprising:
a database storing information about at least one type of lifestyle;
a rules engine defining at least one rule relating to the type of lifestyle;
a processor in operable communication with the rules engine and the database, the processor system programmed for:
receiving user information about a user's desired lifestyle;
retrieving data from the database responsive to the user information, in accordance with the at least one rule; and
creating a plan for the user to achieve the desired lifestyle, in accordance with the retrieved data.

19. The computerized lifestyle planning system of claim 18, wherein the processor is programmed for providing information to the user that permits the user to explore at least one aspect of the plan.

20. The computerized lifestyle planning system of claim 18, wherein the processor is programmed to receive user information that includes user financial information.

21. The computerized lifestyle planning system of claim 18, wherein the processor is further programmed to retrieve user information from an entity other than the user.

22. The computerized lifestyle planning system of claim 18, wherein the processor is further programmed to provide at least one of the desired lifestyle, user information, and plan to an entity other than the user.

23. The computerized lifestyle planning system of claim 18, wherein the computerized lifestyle planning system communicates with the user over a computer network.

24. A computer program product, comprising:
a computer useable medium and computer readable code embodied on the computer useable medium for creating a lifestyle plan for a user, the computer readable code comprising:
computer readable program code devices configured to cause the computer to identify a user's desired lifestyle;
computer readable program code devices configured to cause the computer to identify at least one user preference associated with the desired lifestyle;
computer readable program code devices configured to cause the computer to identify financial information associated with the user;
computer readable program code devices configured to cause the computer to determine the cost of the user's desired lifestyle, in accordance with the preference
computer readable program code devices configured to cause the computer to determine whether the desired lifestyle scenario is achievable with respect to the financial information; and,
computer readable program code devices configured to cause the computer to provide a lifestyle plan associated with the desired lifestyle and the financial information to the user.

25. A computer data signal embodied in a transmission medium, comprising:
a code segment including instructions for identifying a user's desired lifestyle;
a code segment including instructions for identifying at least one user preference associated with the desired lifestyle;
a code segment including instructions for identifying financial information associated with the user;
a code segment including instructions for determining the cost of the user's desired lifestyle, in accordance with the preference
a code segment including instructions for determining whether the desired lifestyle scenario is achievable with respect to the financial information; and,
a code segment including instructions for providing a lifestyle plan associated with the desired lifestyle and the financial information to the user.

26. An interface for creating a lifestyle plan for a user, the interface comprising computer readable program devices for:
identifying a user's desired lifestyle;
identifying at least one user preference associated with the desired lifestyle;
identifying financial information associated with the user;
determining the cost of the user's desired lifestyle, in accordance with the preference determining whether the desired lifestyle scenario is achievable with respect to the financial information; and,
providing a lifestyle plan associated with the desired lifestyle and the financial information to the user.

27. A method in a computer system for evaluating a user lifestyle goal, comprising:
presenting a prompt to the user requesting the selection of a lifestyle goal;
presenting a query to the user relating to the lifestyle goal;
presenting a result to the user indicating at least a portion of the cost of the selected lifestyle goal, the result based at least in part on the user's response to the query;
presenting a prompt to the user requesting user financial information;
presenting an indication to the user as to whether the selected lifestyle goal is achievable, the indication based at least in part on the user financial information; and
presenting a plan to the user for achieving the selected lifestyle goal.

28. A computer readable medium containing a data structure for storing lifestyle information and a set of scores for evaluating lifestyle preferences provided by a user against financial information associated with the user, the lifestyle information and scores indicating the degree of correlation between the lifestyle preferences and the financial information, the data structure comprising:
a user table containing an entry for the user, the entry specifying an index to a set of lifestyle preferences provided by a user in response to a set of queries provided to the user, the entry further specifying an index to a set of financial information associated with the user; and
a comparison table containing a threshold value corresponding to a minimum level of correlation between the lifestyle preferences of the user and the financial information associated with the user, the minimum level indicating whether the user's lifestyle preferences are achievable.
